(19) United States
(12) Patent Application Publication
(10) Pub. No.: US 2025/0080278 A1
(43) Pub. Date: Mar. 6, 2025

(54) DUPLICATE ACKNOWLEDGMENT MESSAGE REDUCTION PROCEDURES

(71) Applicant: QUALCOMM Incorporated, San Diego, CA (US)

(72) Inventors: Sitaramanjaneyulu KANAMARLAPUDI, San Diego, CA (US); Arnaud MEYLAN, San Diego, CA (US); Yubing JIAN, San Diego, CA (US)

(21) Appl. No.: 18/459,772

(22) Filed: Sep. 1, 2023

(51) Int. Cl. H04L 1/1607; H04W 28/06

(52) U.S. Cl. CPC H04L 1/1657; H04L 1/1642; H04W 28/06

(57) ABSTRACT

Methods, systems, and devices for wireless communication are described. A device may transmit or receive multiple data packets via a data connection established via a wireless channel. The multiple data packets may be a sequence of data packets. The device may identify a quantity of duplicate acknowledgment (ACK) messages, where a first ACK message may be identified as being a duplicate ACK message based on a second ACK message indicating successful receipt of a same packet as the first ACK message and successful receipt of one or more subsequent packets in the sequence of data packets, and based on the second ACK message being generated within a time duration threshold of the first ACK message. The device may perform a duplicate ACK recovery procedure based on the quantity of duplicate ACK messages satisfying a trigger threshold.

### FIELD OF TECHNOLOGY

The following relates to wireless communication, including duplicate acknowledgment (ACK) message reduction procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support duplicate acknowledgment (ACK) message reduction procedures. For example, the described techniques may enable a device (e.g., a wireless device, a network device) to transmit or receive multiple data packets via a data connection established via a wireless channel. The multiple data packets may be a sequence of data packets (e.g., data packets in a sequential order based on a sequence number). The device may respond to receiving the multiple data packets by transmitting one or more ACK messages to indicate whether a data packet was successfully received. In some examples, the device may identify a quantity of duplicate ACK messages that are generated for the multiple data packets, where a first ACK message may be identified as being a duplicate ACK message based on a second ACK message that indicates successful receipt of a same packet as the first ACK message (e.g., and successful receipt of one or more subsequent packets in the sequence of data packets), and based on the second ACK message being generated within a time duration threshold of the first ACK message. Based on the quantity of identified duplicate ACK messages satisfying a trigger threshold, the device may perform a duplicate ACK recovery (e.g., reduction) procedure.

A method for wireless communications by a wireless device is described. The method may include transmitting or receiving a set of multiple data packets via a data connection established via a wireless channel, the set of multiple data packets being a sequence of data packets communicated via the data connection, identifying a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message, and performing a duplicate ACK recovery procedure based on the quantity of duplicate ACK messages satisfying a trigger threshold.

A wireless device for wireless communications is described. The wireless device may include one or more memories storing processor executable code, and one or more processors coupled with the one or more memories. The one or more processors may individually or collectively operable to execute the code to cause the wireless device to transmit or receive a set of multiple data packets via a data connection established via a wireless channel, the set of multiple data packets being a sequence of data packets communicated via the data connection, identify a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message, and perform a duplicate ACK recovery procedure based on the quantity of duplicate ACK messages satisfying a trigger threshold.

Another wireless device for wireless communications is described. The wireless device may include means for transmitting or receiving a set of multiple data packets via a data connection established via a wireless channel, the set of multiple data packets being a sequence of data packets communicated via the data connection, means for identifying a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message, and means for performing a duplicate ACK recovery procedure based on the quantity of duplicate ACK messages satisfying a trigger threshold.

A non-transitory computer-readable medium storing code for wireless communications is described. The code may include instructions executable by a processor to transmit or receive a set of multiple data packets via a data connection established via a wireless channel, the set of multiple data packets being a sequence of data packets communicated via the data connection, identify a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message, and perform a duplicate ACK recovery procedure based on the quantity of duplicate ACK messages satisfying a trigger threshold.

In some examples of the method, wireless devices, and non-transitory computer-readable medium described herein, one or more of the time duration threshold or the trigger threshold may be based on one or more channel condition metrics of the wireless channel.

In some examples of the method, wireless devices, and non-transitory computer-readable medium described herein, the one or more channel condition metrics of the wireless channel includes a pathloss metric, a round trip time (RTT), a layer two (L2) RTT, an end-to-end (E2E) RTT, a block error rate (BLER), a layer one (L1) BLER, an L2 BLER, or any combination thereof.

In some examples of the method, wireless devices, and non-transitory computer-readable medium described herein, one or more of the time duration threshold or the trigger threshold may be based on a radio access technology (RAT) type of the wireless device used to communicate the set of multiple data packets, a sub-carrier spacing (SCS) used to communicate the set of multiple data packets, a frequency band used to communicate the set of multiple data packets, or any combination thereof.

In some examples of the method, wireless devices, and non-transitory computer-readable medium described herein, one or more of the time duration threshold or the trigger threshold may be based on a configuration of a communication protocol used for communicating the set of multiple data packets via the data connection.

Some examples of the method, wireless devices, and non-transitory computer-readable medium described herein may further include operations, features, means, or instructions for transmitting or receiving the second ACK message via the data connection.

In some examples of the method, wireless devices, and non-transitory computer-readable medium described herein, the set of multiple data packets may be received by the wireless device in accordance with the sequence and forwarded to a protocol layer stack for generating ACK messages in a different sequential order.

In some examples of the method, wireless devices, and non-transitory computer-readable medium described herein, the time duration threshold may be based on an E2E RTT for a transmission of at least one data packet of the set of multiple data packets from a transmitter to the wireless device.

In some examples of the method, wireless devices, and non-transitory computer-readable medium described herein, the duplicate ACK recovery procedure may include operations, features, means, or instructions for removing one or more ACK messages identified as being a duplicate from a transmission buffer.

In some examples of the method, wireless devices, and non-transitory computer-readable medium described herein, the duplicate ACK recovery procedure may include operations, features, means, or instructions for removing one or more ACK messages identified as being a duplicate from a receive buffer.

In some examples of the method, wireless devices, and non-transitory computer-readable medium described herein, the duplicate ACK recovery procedure may include operations, features, means, or instructions for transmitting a retransmission of a duplicate ACK message having a first payload that may be different than a second payload communicated in a prior transmission of the duplicate ACK message, where the first payload fails to satisfy a checksum or error check procedure associated with the duplicate ACK message.

In some examples of the method, wireless devices, and non-transitory computer-readable medium described herein, the duplicate ACK recovery procedure indicates that transmission of the second ACK message may be prioritized over transmission of the first ACK message via a radio bearer, a logical channel, or both.

In some examples of the method, wireless devices, and non-transitory computer-readable medium described herein, the duplicate ACK recovery procedure may include operations, features, means, or instructions for transmitting or receiving the second ACK message over a first radio link, a first component carrier, or both and transmitting or receiving the second ACK message over a second radio link, a second component carrier, or both.

In some examples of the method, wireless devices, and non-transitory computer-readable medium described herein, identifying the quantity of duplicate ACK messages may include operations, features, means, or instructions for identifying the quantity of duplicate ACK messages during an observation time window, where a duration of the observation time window may be based on one or more channel condition metrics of the wireless channel.

In some examples of the method, wireless devices, and non-transitory computer-readable medium described herein, the one or more channel condition metrics of the wireless channel includes a pathloss metric, an RTT, an L2 RTT, an E2E RTT, a BLER, an L1 BLER, an L2 BLER, or any combination thereof.

In some examples of the method, wireless devices, and non-transitory computer-readable medium described herein, the duration of the observation time window may be based on a RAT type of the wireless device used to communicate the set of multiple data packets, an SCS used to communicate the set of multiple data packets, a frequency band used to communicate the set of multiple data packets, or any combination thereof.

In some examples of the method, wireless devices, and non-transitory computer-readable medium described herein, the duration of the observation time window may be based on a configuration of a communication protocol used for communicating the set of multiple data packets via the data connection.

### BRIEF DESCRIPTION OF THE DRAWINGS

FIG. 1 shows an example of a wireless communications system that supports duplicate acknowledgment (ACK) message reduction procedures in accordance with one or more aspects of the present disclosure.

FIG. 2 shows an example of a network architecture that supports duplicate ACK message reduction procedures in accordance with one or more aspects of the present disclosure.

FIGS. 3 and 4 show examples of wireless communications systems that support duplicate ACK message reduction procedures in accordance with one or more aspects of the present disclosure.

FIG. 5 shows an example of a flowchart that supports duplicate ACK message reduction procedures in accordance with one or more aspects of the present disclosure.

FIG. 6 shows an example of a process flow that supports duplicate ACK message reduction procedures in accordance with one or more aspects of the present disclosure.

FIGS. 7 and 8 show block diagrams of devices that support duplicate ACK message reduction procedures in accordance with one or more aspects of the present disclosure.

FIG. 9 shows a block diagram of a communications manager that supports duplicate ACK message reduction procedures in accordance with one or more aspects of the present disclosure.

FIG. 10 shows a diagram of a system including a device that supports duplicate ACK message reduction procedures in accordance with one or more aspects of the present disclosure.

FIGS. 11 through 14 show flowcharts illustrating methods that support duplicate ACK message reduction procedures in accordance with one or more aspects of the present disclosure.

### DETAILED DESCRIPTION

Some wireless communications systems may use one or more communication protocols (e.g., transport protocols) to transmit and receive data. Some communication protocols (e.g., transmission control protocol (TCP)), may be lossless protocols, which may include procedures to recover data packets that are lost during communication (e.g., before the data packet is received). In some cases, a device (e.g., a wireless device, a network device) may expect to receive data packets in accordance with a sequence of data packets, where each data packet may be associated with a respective sequence number (e.g., the sequence of data packets may be transmitted in sequential order). After each successful reception of a data packet, the device may transmit an acknowledgment (ACK) message indicating that a data packet was successfully received and that the device may be ready to receive a subsequent data packet in the sequence.

In some cases, the device may identify that a data packet is missing from the sequence based on receiving one or more data packets out of sequential order (e.g., a receiver may expect to receive packet P3 but receives packet P4). For example, if a first device identifies a missing data packet in the sequence, the first device may transmit a duplicate ACK message, which may be a duplicate of a previously transmitted ACK message. Based on receiving a duplicate ACK message, a second device may retransmit the missing data packet associated with the duplicate ACK message (e.g., to recover the lost packet). However, in some cases, the missing data packet may arrive at the first device before the second device is able to perform the retransmission. In some cases, the first device may still transmit the duplicate ACK message (e.g., as if the data packet was lost), even though the first device may eventually receive all the data packets in the sequence of data packets. The duplicate ACK messages may result in redundant retransmissions of data packets that have already been successfully received. Further, the second device may perform other procedures to avoid additional data packet loss, such as reducing transmission buffer sizes and reducing transmission rates. Thus, some duplicate ACK messages may lead to decreased throughput, increased signaling overhead, increased latency, and other adverse effects in a wireless communications system.

In accordance with aspects described herein, a device (e.g., a wireless device, a network device) may support techniques to reduce duplicate ACK messages. In some examples, a device may receive (e.g., or transmit) a sequence of data packets via a data connection (e.g., with a second device). The device may identify a quantity of duplicate ACK messages (e.g., redundant duplicate ACK messages, short-lived duplicate ACK messages) that are generated (e.g., or received) for the sequence of data packets. In some examples, a device may identify a first ACK message as a duplicate ACK message based on a second ACK message (e.g., a pure ACK message) indicating successful receipt of a same packet as the first ACK message and successful receipt of one or more subsequent packets in the sequence of data packets. The device may further identify a first ACK message as a duplicate ACK message based on the second ACK message being generated (e.g., or received) within a time duration threshold of the first ACK message. The device may perform a duplicate ACK recovery procedure based on the quantity of duplicate ACK messages satisfying a trigger threshold. In accordance with supporting performance of a duplicate ACK recovery procedure, a device may refrain from transmitting (e.g., or forwarding) at least some duplicate ACK messages, which may reduce redundant retransmissions of data packets as well as increase system throughput. Thus, a wireless communications system may operate with higher data rates, greater spectral efficiency, and lower latency.

Further, the device may determine one or more parameters associated with identifying the duplicate ACK messages and performing the duplicate ACK recovery procedure. For example, the device may perform the duplicate ACK recovery procedure based on identifying the quantity of duplicate ACK messages during an observation time window. In some examples, the device may determine one or more of the time duration threshold, the trigger threshold, or a duration for the time observation window based on one or more channel condition metrics of the wireless channel, radio technology characteristics, protocol configurations, other communication characteristics, or any combination thereof.

Such implementations of the subject matter described in this disclosure also may be implemented to realize one or more of the following potential advantages. For example, in accordance with determining the one or more parameters, the device may be enabled to dynamically improve throughput performance based on characteristics of a wireless channel. Moreover, the device may be able to compensate for scenarios where packets become out-of-order, which may mitigate adverse impacts on throughput performance and latency (e.g., in TCP or other lossless protocols). Accordingly, performing the duplicate ACK recovery procedure may enable higher throughput, reduced latency, increased efficiency, and other benefits, resulting in improved user experience.

Aspects of the disclosure are initially described in the context of wireless communications systems. Aspects of the disclosure are further illustrated by and described with reference to flowcharts, process flows, apparatus diagrams, and system diagrams that relate to duplicate ACK message reduction procedures.

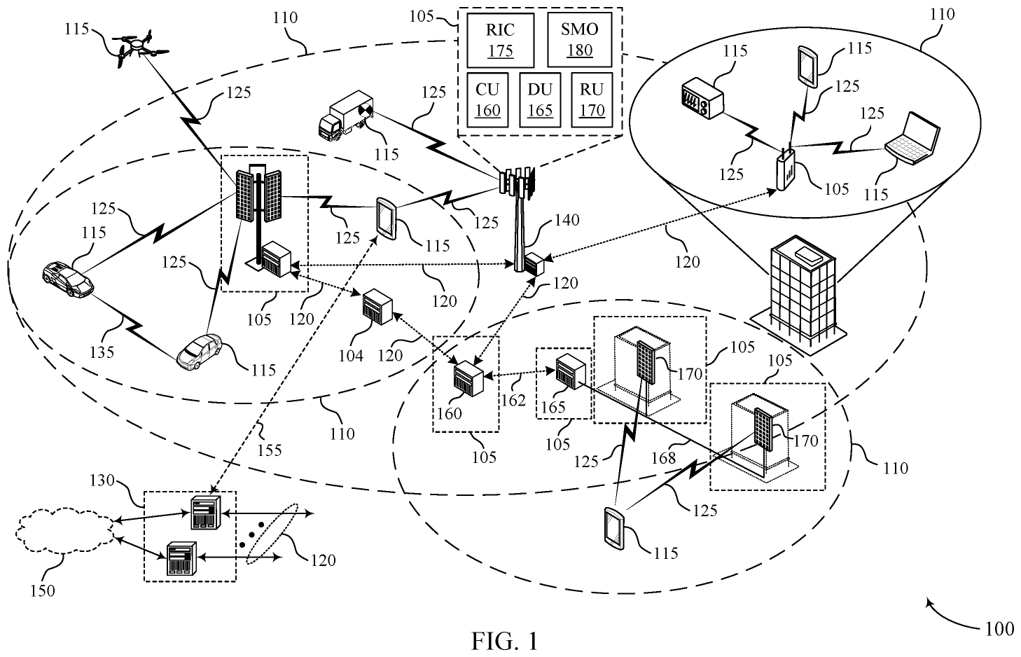

FIG. 1 shows an example of a wireless communications system 100 that supports duplicate ACK message reduction procedures in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, NG interface, NG-C interface, NG user plane (NG-U) interface, or other interface protocol). In some examples, network entities 105 may communicate with one another via a backhaul communication link 120 (e.g., in accordance with an X2, Xn, Xn user plane (Xn-U) interface, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (cNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer three (L3), layer two (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer one (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support duplicate ACK message reduction procedures as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking. Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some cases, network nodes (e.g., NG-RAN nodes, gNBs and ng-cNBs) may be connected via an Xn interface. The network nodes may also be connected by means of NG interfaces to a core network (e.g., 5GC) device such as an AMF or UPF. For example, gNBs and ng-eNBs (e.g., or other network devices) may connect to an AMF via an NG-C interface and to a UPF via an NG-U interface. The NG-U interface may be defined between an NG-RAN node and a UPF. A transport network layer may be built on IP transport and general packet radio service tunneling protocol (GTP) user (GTP-U) may be used on top of user datagram protocol (UDP) or IP to carry the user plane protocol data units (PDUs) between the NG-RAN node and the UPF. In some cases, NG-U may provide non-guaranteed delivery of user plane PDUs between the NG-RAN node and the UPF. In some cases, a node hosting an NR PDCP entity may assign consecutive NR-U sequence numbers to each transferred NR-U packet. A retransmitted NR PDCP PDU may be assigned a new NR-U sequence number.

Additionally, the Xn-U interface may defined between two NG-RAN nodes. In some cases, the Xn-U interface may provide non-guaranteed delivery of user plane PDUs between two NG-RAN nodes. In some cases, user plane packets conveyed by GTP-U may PDCP PDUs (e.g., in case of dual connectivity), PDCP Service Data Units (SDUs) (e.g., in case of data radio bearer (DRB) level data forwarding), or SDAP SDUs (e.g., in PDU Session level data forwarding). User plane protocol messages may be carried by container fields in a GTP-U extension header. A single GTP-U packet may carry a user plane packet and/or a user plane protocol message. As NG-U or NR-U or Xn-U links are based on GTP-U protocol and IP based with non-guaranteed delivery, packet loss may be expected in a core network or between radio network entities.

In some examples, the wireless communications system 100 may use one or more communication protocols (e.g., TCP, GTP-U, IP) to communicate data packets between devices. Additionally, some interfaces and protocols (e.g., Xn, NG-U) may be associated with non-guaranteed delivery, which may result in lost data packets or out-of-order data packets. In some cases, a device (e.g., a wireless device, a network device, a UE 115, a network entity 105) may expect to receive an ordered sequence of data packets (e.g., the packets may be transmitted in sequential order). However, due to the non-guaranteed delivery, network topology, network conditions, device configurations, or various other factors, data packets may arrive at a device out-of-sequence. A device may treat data packets received out-of-order as lost data packets (e.g., until the data packets arrive at the device), and the device may transmit duplicate ACK messages to recover (e.g., request) the lost data packet. Even though the data packet may not be lost (e.g., the out-of-order data packet may shortly arrive), the device may transmit the duplicate ACK message, which may trigger precautionary measures, such as data packet retransmission and reduced scheduling of communications, to avoid further packet loss. However, such measures may reduce overall throughput and increase latency in the wireless communications system 100, among other adverse effects.

To reduce adverse effects associated with some duplicate ACK messages, a device may identify a quantity of duplicate ACK messages (e.g., short-lived duplicate ACKs) that are observed within a time window and perform a duplicate ACK recovery procedure if the quantity of duplicate ACK messages satisfies (e.g., exceeds) a trigger threshold. In some examples, a first ACK message may be identified as a duplicate ACK message based on a second ACK message (e.g., a pure ACK message) being generated (e.g., or received) within a time duration threshold of the first ACK message. The second ACK message may indicate successful receipt of a same packet as the first ACK message and successful receipt of one or more subsequent packets in the sequence of data packets. Performing duplicate ACK recovery procedures described herein may enable a device to limit transmissions (e.g., or forwarding) of at least some duplicate ACK messages, which may increase data rates, increase throughput metrics, and reduce latency.

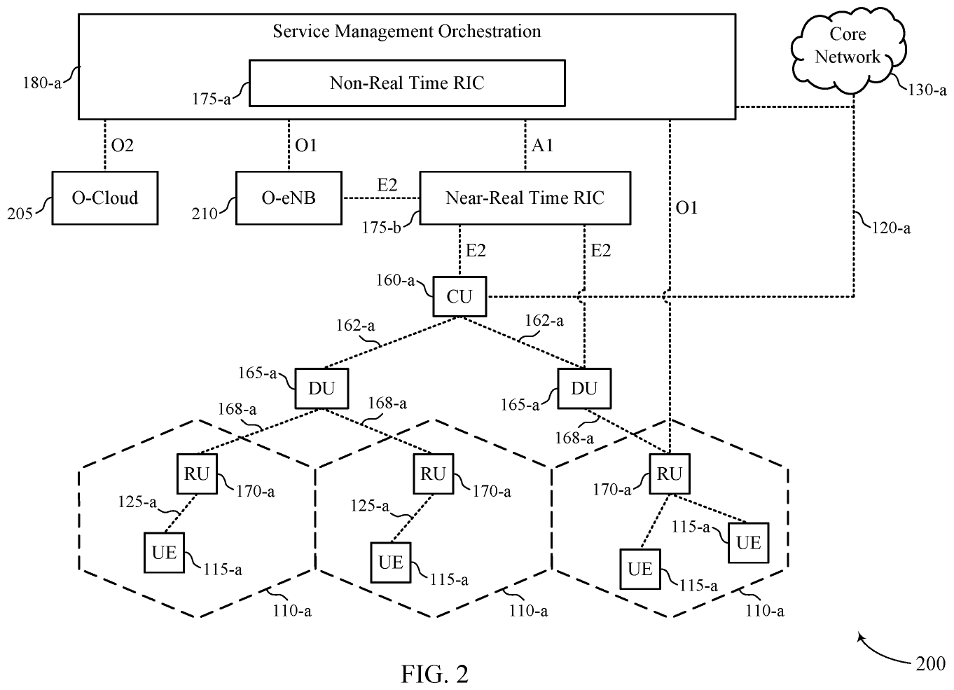

FIG. 2 shows an example of a network architecture 200 (e.g., a disaggregated base station architecture, a disaggregated RAN architecture) that supports duplicate ACK message reduction procedures in accordance with one or more aspects of the present disclosure. The network architecture 200 may illustrate an example for implementing one or more aspects of the wireless communications system 100. The network architecture 200 may include one or more CUs 160-a that may communicate directly with a core network 130-a (e.g., an AMF, a UPF) via a backhaul communication link 120-a, or indirectly with the core network 130-a through one or more disaggregated network entities 105 (e.g., a Near-RT RIC 175-b via an E2 link, or a Non-RT RIC 175-a associated with an SMO 180-a (e.g., an SMO Framework), or both). A CU 160-a may communicate with one or more DUs 165-a via respective midhaul communication links 162-a (e.g., an F1 interface). The DUs 165-a may communicate with one or more RUs 170-a via respective fronthaul communication links 168-a. The RUs 170-a may be associated with respective coverage areas 110-a and may communicate with UEs 115-a via one or more communication links 125-a. In some implementations, a UE 115-a may be simultaneously served by multiple RUs 170-a.

Each of the network entities 105 of the network architecture 200 (e.g., CUs 160-a. DUs 165-a. RUs 170-a, Non-RT RICs 175-a, Near-RT RICs 175-b, SMOs 180-a, Open Clouds (O-Clouds) 205, Open eNBs (O-eNBs) 210) may include one or more interfaces or may be coupled with one or more interfaces configured to receive or transmit signals (e.g., data, information) via a wired or wireless transmission medium. Each network entity 105, or an associated processor (e.g., controller) providing instructions to an interface of the network entity 105, may be configured to communicate with one or more of the other network entities 105 via the transmission medium. For example, the network entities 105 may include a wired interface configured to receive or transmit signals over a wired transmission medium to one or more of the other network entities 105. Additionally, or alternatively, the network entities 105 may include a wireless interface, which may include a receiver, a transmitter, or transceiver (e.g., an RF transceiver) configured to receive or transmit signals, or both, over a wireless transmission medium to one or more of the other network entities 105.

In some examples, a CU 160-a may host one or more higher layer control functions. Such control functions may include RRC, PDCP. SDAP, or the like. Each control function may be implemented with an interface configured to communicate signals with other control functions hosted by the CU 160-a. A CU 160-a may be configured to handle user plane functionality (e.g., CU-UP), control plane functionality (e.g., CU-CP), or a combination thereof. In some examples, a CU 160-a may be logically split into one or more CU-UP units and one or more CU-CP units. A CU-UP unit may communicate bidirectionally with the CU-CP unit via an interface, such as an E1 interface when implemented in an O-RAN configuration. A CU 160-a may be implemented to communicate with a DU 165-a, as necessary, for network control and signaling.

A DU 165-a may correspond to a logical unit that includes one or more functions (e.g., base station functions, RAN functions) to control the operation of one or more RUs 170-a. In some examples, a DU 165-a may host, at least partially, one or more of an RLC layer, a MAC layer, and one or more aspects of a PHY layer (e.g., a high PHY layer, such as modules for FEC encoding and decoding, scrambling, modulation and demodulation, or the like) depending, at least in part, on a functional split, such as those defined by the 3rd Generation Partnership Project (3GPP). In some examples, a DU 165-a may further host one or more low PHY layers. Each layer may be implemented with an interface configured to communicate signals with other layers hosted by the DU 165-a, or with control functions hosted by a CU 160-a.

In some examples, lower-layer functionality may be implemented by one or more RUs 170-a. For example, an RU 170-a, controlled by a DU 165-a, may correspond to a logical node that hosts RF processing functions, or low-PHY layer functions (e.g., performing fast Fourier transform (FFT), inverse FFT (iFFT), digital beamforming, physical random access channel (PRACH) extraction and filtering, or the like), or both, based at least in part on the functional split, such as a lower-layer functional split. In such an architecture, an RU 170-a may be implemented to handle over the air (OTA) communication with one or more UEs 115-a. In some implementations, real-time and non-real-time aspects of control and user plane communication with the RU(s) 170-a may be controlled by the corresponding DU 165-a. In some examples, such a configuration may enable a DU 165-a and a CU 160-a to be implemented in a cloud-based RAN architecture, such as a vRAN architecture.

The SMO 180-a may be configured to support RAN deployment and provisioning of non-virtualized and virtualized network entities 105. For non-virtualized network entities 105, the SMO 180-a may be configured to support the deployment of dedicated physical resources for RAN coverage requirements which may be managed via an operations and maintenance interface (e.g., an O1 interface). For virtualized network entities 105, the SMO 180-a may be configured to interact with a cloud computing platform (e.g., an O-Cloud 205) to perform network entity life cycle management (e.g., to instantiate virtualized network entities 105) via a cloud computing platform interface (e.g., an O2 interface). Such virtualized network entities 105 can include, but are not limited to, CUs 160-a, DUs 165-a. RUs 170-a, and Near-RT RICs 175-b. In some implementations, the SMO 180-a may communicate with components configured in accordance with a 4G RAN (e.g., via an O1 interface). Additionally, or alternatively, in some implementations, the SMO 180-a may communicate directly with one or more RUs 170-a via an O1 interface. The SMO 180-a also may include a Non-RT RIC 175-a configured to support functionality of the SMO 180-a.

The Non-RT RIC 175-a may be configured to include a logical function that enables non-real-time control and optimization of RAN elements and resources, Artificial Intelligence (AI) or Machine Learning (ML) workflows including model training and updates, or policy-based guidance of applications/features in the Near-RT RIC 175-b. The Non-RT RIC 175-a may be coupled to or communicate with (e.g., via an A1 interface) the Near-RT RIC 175-b. The Near-RT RIC 175-b may be configured to include a logical function that enables near-real-time control and optimization of RAN elements and resources via data collection and actions over an interface (e.g., via an E2 interface) connecting one or more CUs 160-a, one or more DUs 165-a, or both, as well as an O-eNB 210, with the Near-RT RIC 175-b.

In some examples, to generate AI/ML models to be deployed in the Near-RT RIC 175-b, the Non-RT RIC 175-a may receive parameters or external enrichment information from external servers. Such information may be utilized by the Near-RT RIC 175-b and may be received at the SMO 180-a or the Non-RT RIC 175-a from non-network data sources or from network functions. In some examples, the Non-RT RIC 175-a or the Near-RT RIC 175-b may be configured to tune RAN behavior or performance. For example, the Non-RT RIC 175-a may monitor long-term trends and patterns for performance and employ AI or ML models to perform corrective actions through the SMO 180-a (e.g., reconfiguration via 01) or via generation of RAN management policies (e.g., A1 policies).

In some cases, application traffic may come from a core network 130-a (e.g., a core network UPF entity, an AMF) to a network node (e.g., a CU 160-a, a gNodeB) in a 5G NR environment. The network node (e.g., gNodeB) may be divided into multiple units (e.g., a CU 160-a, a DU 165-a, an RU 170-a) based on the network architecture 200. For example, a network node (e.g., its RAN functionality) may be separated a between CU 160-a and one or more DUs 165-a. In a data plane, the CU 160-a may contain PDCP functionality while the DU 165-a may contain the RLC or MAC functionality. In some cases, core network entities (UPF/AMF/Application Servers) may be connected through an NG-U interface to other RAN entities, and RAN entities may be connected through an Xn-U interface. In such cases, both interfaces may utilize GTP-U tunnel based UDP/IP mechanisms for data plane, which may not guarantee delivery of data packets. As such, packet loss may be expected in the core network or between RAN entities

In some examples, the network architecture 200 may use one or more communication protocols (e.g., TCP, GTP-U, IP) to communicate data packets between devices (e.g., nodes, CUs 160-a, DUs 165-a, RUs 170-a). Additionally, some interfaces and protocols may be associated with non-guaranteed delivery, which may result in lost data packets or out-of-order data packets. In some cases, due to the non-guaranteed delivery, network topology (e.g., separations of network node functionality), network conditions, device configurations, or various other factors, data packets may arrive at a device out-of-order, which may result in duplicate ACK messages leading to undesirable system performance. To increase system performance, a device may identify that a quantity of duplicate ACK messages (e.g., short-lived duplicate ACKs) satisfies a threshold quantity and may perform a duplicate ACK recovery procedure. Performing duplicate ACK recovery procedures, as described herein, may enable a device to increase data rates, increase throughput, and reduce latency.

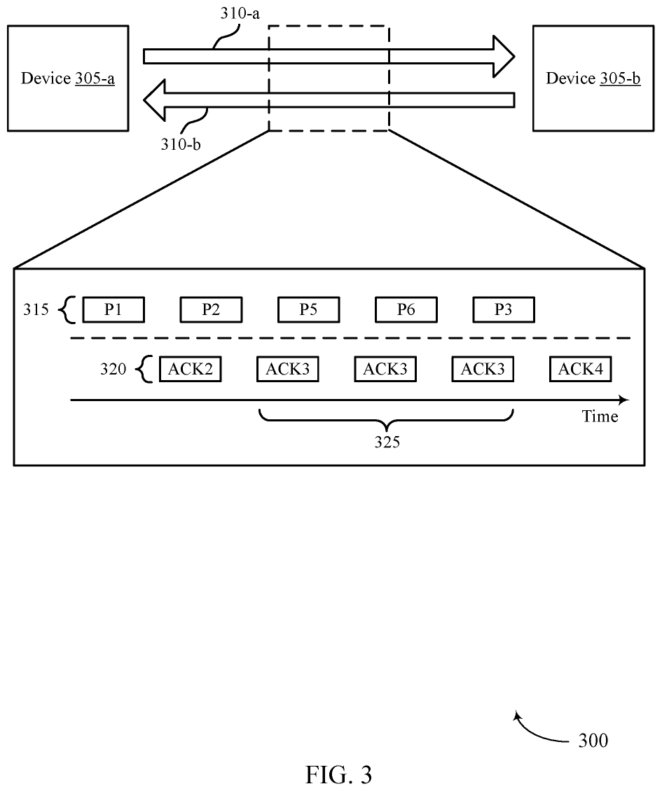

FIG. 3 shows an example of a wireless communications system 300 that supports duplicate ACK message reduction procedures in accordance with one or more aspects of the present disclosure. In some examples, the wireless communications system 300 may implement or be implemented by aspects of the wireless communications system 100 or the network architecture 200. The wireless communications system 300 may include one or more devices 305 (e.g., wireless devices, network devices) such as a device 305-a and a device 305-b. In some examples, the device 305-a and the device 305-b may be examples of or include UEs 115, network entities 105, CUs 160, DUs 165, RUs 170, network nodes, or other devices as described with reference to FIGS. 1 and 2. The device 305-a and the device 305-b may communicate via a communication link 310. For example, the device 305-a may transmit communications (e.g., data packets, commands, messages, or other signaling) to the device 305-b via a communication link 310-a, and the device 305-b may transmit communications to the device 305-a via a communication link 310-b. The communication link 310-a and the communication link 310-b may be examples of or include downlink communication interfaces, uplink communication interfaces, sidelink communication interfaces, Xn interfaces (e.g., Xn-U), NG interfaces (e.g., NG-U. NG-C), or other communication interfaces.

Some wireless communications systems support transport protocols (e.g., TCP, GTP-U) to exchange data between devices 305. For instance, a device 305-a may transmit data to a device 305-b via one or more data packets 315 (e.g., P1, P2, P3, and so on), which may also be referred to herein as packets, as part of the transport protocol. Some transport protocols may be lossless transport protocols (e.g., TCP), which may include congestion control and other mechanisms to mitigate loss of data packets 315. In some cases, the congestion control may assume that packet loss occurs when a transmission rate (e.g., a sender's rate) at a transmitter (e.g., the device 305-a) exceeds the capacity of the network (e.g., resulting in buffer overflow). In response some lossless transport protocols, such as TCP, may reduce the transmission rate.

In some cases, lossless transport protocols may include ACK procedures to coordinate communications between devices 305 and mitigate lost data packets. For example, a device 305-a may transmit one or more data packets 315 (e.g., via a communication link 310-a) in accordance with a sequential order, where each data packet 315 is associated with a respective sequence number. A device 305-b may expect to receive the one or more data packets 315 in accordance with the sequential order, and may respond with one or more ACK messages 320 (e.g., TCP ACKs, via a communication link 310-b) to indicate whether a particular packet was received or not received. For instance, the device 305-a may transmit a first packet, P1, to the device 305-b. If the device 305-b successfully receives (e.g., decodes, processes) the packet P1, the device 305-b may respond with (e.g., transmit) an ACK message 320 (e.g., ACK2) to the device 305-a. The ACK message 320 may indicate a successful receipt of the data packet and a request to for the device 305-a to transmit (e.g., or an indication that the device 305-b is ready to receive) a subsequent data packet (e.g., in accordance with the sequential order). For example, the ACK2 message may indicate successful receipt of P1 and a request for transmission of P2, the ACK3 messages may indicate successful receipt of P2 and a request for transmission of P3, and so on.

However, in some cases, some packets of the one or more data packets 315 may become out-of-order or lost before arriving at the device 305-b (e.g., due to varying communication routes among the packets, wireless channel conditions, device processing capabilities, network topology, protocol configurations, among other conditions). That is, the device 305-a may transmit the one or more data packets 315 in-order (e.g., P1, P2, P3, P4, P5, P6), but may arrive at the device 305-b out-of-order (e.g., P1, P2, P5, P6, P3) or may fail to arrive at the device 305-b. If the device 305-b receives a packet that is not in accordance with an expected sequential order (e.g., a packet is received out-of-order or lost), the device 305-b may transmit a duplicate ACK message (e.g., a duplicate of a previous ACK message 320).

For example, the device 305-b may successfully receive packets P1 and P2 and may accordingly transmit ACK messages ACK2 and ACK3. In accordance with the sequential order, the device 305-b may expect to receive packet P3, but instead may receive packets P5 and P6. Accordingly, the device 305-b may transmit duplicate ACK messages of ACK3 (e.g., requesting retransmission of P3) until it successfully receives P3 (e.g., or until a threshold quantity of duplicate ACK messages are transmitted). After receiving ACK3, the device 305-b may transmit ACK4 to request transmission of P4, and so on. In some cases (e.g., in TCP), transmission of at least three duplicate ACK messages may indicate a packet loss. In other words, if a packet is two packets out of sequence, it may appear as packet loss (e.g., P3 may appear as being lost).

In some cases of TCP, a metric for TCP performance may be a duration of a duplicate ACK event, which may measure how long the TCP (e.g., a TCP device, the device 305-b) continues transmitting an ACK message 320 for a same sequence number (e.g., a time duration 325). The duration of the duplicate ACK event may represent the time duration to recover the data packet that the device 305-b (e.g., a TCP receiver) is missing. In some cases of a lost packet, the device 305-b may transmit a duplicate ACK message. The device 305-a may interpret the duplicate ACK message as a loss (e.g., a lost packet) and may retransmit the missing packet(s). In some cases, a time to receive a retransmission of a data packet may take at least a round trip time (RTT) duration. In some cases, however, a duplicate ACK event (e.g., the time duration 325) may be shorter than the RTT, which may indicate that a packet was not lost, because a packet retransmission from the device 305-a may not be able to arrive faster than the RTT. Accordingly, a duplicate ACK event shorter than the RTT may indicate that the data packet became out-of-order (e.g., out of sequence) but eventually arrived, and may, in some examples, be referred to as a “short-lived” duplicate ACK message.

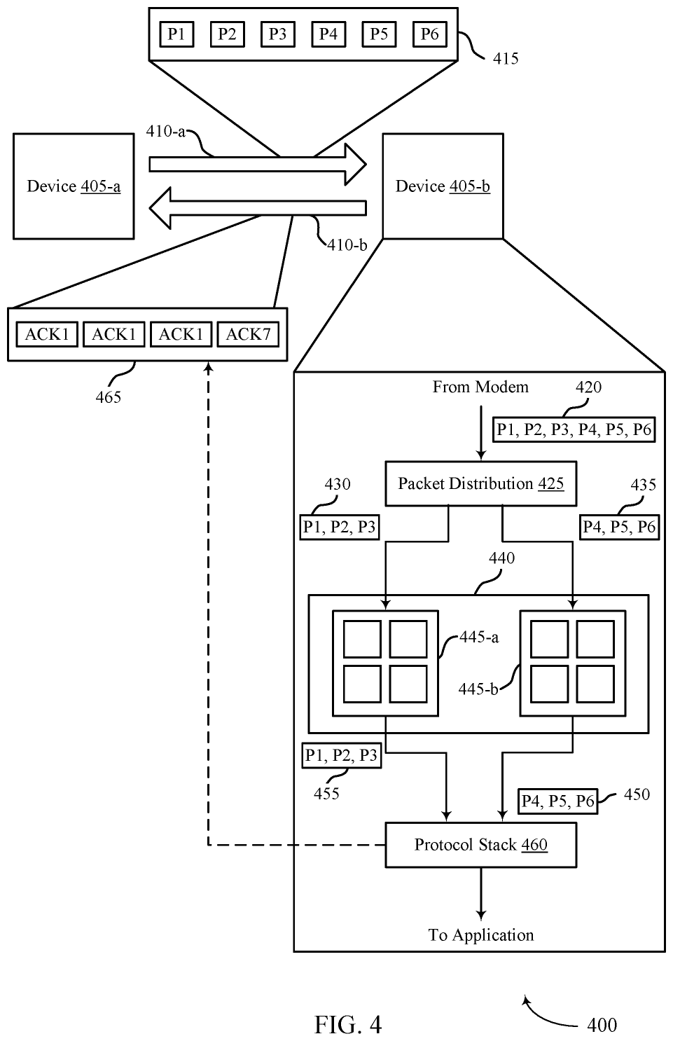

In some cases, data packets 315 may become out-of-order (e.g., before arriving at a receiver) based on packet routing procedures (e.g., communication traffic routing) via a network core (e.g., an internet core, a 5G core). For instance, some transport protocols (e.g., IP) use per-packet (e.g., stateless) routing, which may use dynamic routing metrics. For example, packets n+1 . . . , n+k may use a different route than packets n−1, n, n+k+1. In such examples, the end point may likely be associated with out-of-order reception (e.g., at a device 305-b). In some other examples, some devices may communicate using interfaces (e.g., Xn-U, NG-U, NR-U) that may be based on protocols (e.g., GTP-U, IP) associated with non-guaranteed delivery of data packets (e.g., user plane protocol data units PDUs), which may result in data packets 315 arriving out-of-order at a receiver (e.g., the device 305-b). In some other examples, out-of-order packets may occur based on an implementation at a device 305, which may be described in further detail herein, for example, with reference to FIG. 4.

Some applications (e.g., not associated with lossless transport protocols, UE applications) may not be sensitive to out-of-order data packets 315 (e.g., may not transmit duplicate ACK messages, or perform other actions based on receiving out-of-order packets). However, applications associated with lossless protocols may be especially sensitive to packet loss and packet out-of-order scenarios, which may result in adverse effects in a wireless communications system. For example, a device 305-b may receive (e.g., via downlink) multiple data packets for a TCP application from a device 305-a, where one or more of the multiple data packets are delivered out-of-order (e.g., P3). The device 305-b may accordingly transmit (e.g., via uplink) duplicate ACK messages to the device 305-a to recover the “missing” (e.g., out-of-order) data packets. The device 305-a may then retransmit the data packets as requested by the duplicate ACK messages (e.g., even though the device 305-b may have already received the original data packets), resulting in excess and inefficient utilization of communication resources.

Additionally, the duplicate ACK messages may trigger other procedures (e.g., TCP window scaling) at the device 305-a which may reduce scheduling of transmissions (e.g., through window management). As a result, a buffer (e.g., a downlink buffer) size may reduce at the device 305-a (e.g., at the network, until window scaling up occurs), which may cause decreased throughput in communication traffic. In other words, even though the device 305-b may eventually transmit a valid ACK message (e.g., a pure ACK message) for an out-of-order data packet 315, the redundant duplicate ACK message may have already adversely affected the wireless communications system 300, by reducing throughput (e.g., based on impacted TCP downlink window and reduced buffers) between the device 305-b and the device 305-a, among other adverse effects. Thus, it may be desirable for a wireless communications system 300 to compensate for duplicate ACK messages that are associated with out-of-order packets to improve system efficiency.

According to techniques herein, a device 305 may support techniques to identify duplicate ACK messages that are associated with out-of-order data packets (e.g., may identify short-lived duplicate ACK messages). For example, a device 305 may compare a time duration between a duplicate ACK message and a valid ACK message (e.g., a pure ACK) to a time duration threshold (e.g., an RTT). Based on a device identifying a quantity of such duplicate ACK messages within an observation time window, the device 305 may be able to perform one or more recovery procedures to reduce the adverse effects associated with redundant duplicate ACK messages. The recovery procedures may include removing duplicate ACK messages from a buffer at the device 305, modifying a payload for the duplicate ACK messages, prioritizing transmission of ACK messages, duplicating transmission of ACK messages among other techniques described herein (e.g., as described in further detail with reference to FIGS. 4 through 6).

FIG. 4 shows an example of a wireless communications system 400 that supports duplicate ACK message reduction procedures in accordance with one or more aspects of the present disclosure. In some examples, the wireless communications system 400 may implement or be implemented by aspects of the wireless communications system 100, the network architecture 200, or the wireless communications system 300. For example, the wireless communications system 400 may include a device 405-a and a device 405-b, which may be examples of or include devices 305 as described with reference to FIG. 3. The device 405-a and the device 405-b may communicate via one or more communication links 410 such as a communication link 410-a and a communication link 410-b, which may be examples of or include communication links 310 as described with reference to FIG. 3.

The wireless communications system 400 may support multiple transport protocols to enable communication between devices 405. For example, the wireless communications system 400 may support lossless transport protocols (e.g., TCP), which may be sensitive to data packets 415 that arrive out-of-order or fail to arrive at a receiver (e.g., a device 405-b). For instance, the device 405-b may transmit ACK messages 465 including one or more duplicate ACK messages to recover out-of-order or lost packets, resulting in retransmission of one or more data packets 415 by the device 405-a.

In some cases, data packets 415 may arrive at a receiver (e.g., at a TCP stack within a modem, a host, or elsewhere within a device 405) out-of-order based on an implementation (e.g., in hardware, software, or otherwise implemented) at a device 405. For example, as illustrated in FIG. 4, a device 405-a (e.g., a network node) may transmit multiple data packets 415 via a communication link 410-a in accordance with a sequence: P1, P2, P3, P4, P5, P6 (e.g., in sequential order). A device 405-b may receive the data packets 415 via a modem and deliver the data packets 415 to a packet distribution unit 425 (e.g., IP accelerator hardware entities, packet/flow distribution between cores). At 420, the data packets 415 may be received from the modem in accordance with the sequence, and the packet distribution unit 425 may distribute the data packets 415 through different paths (e.g., different hardware paths). In some cases, the data packets 415 may be distributed through different paths based on a flow rate (e.g., the flow can be switched from one path to another path). In some cases, different paths may include coalescing paths, low latency paths, default paths, or other paths (e.g., in an IP accelerator). As such, if enough guard time is not followed during path distribution (e.g., path switch), the data packets 415 may become out-of-order (e.g., at TCP level).

In some cases, the host processor 440 may include multiple processor cores 445, where each processor core 445 may be associated with different processing capabilities (e.g., processing speed). In such cases, different flows (e.g., groups of data packets 415) may be routed through different processing cores 445 to distribute processing of the data packets 415 across the processing cores 445 to improve overall throughput. For example, when a specific flow rate is greater than a threshold, the flow may be routed from a processing core 445-a (e.g., a silver core) to a processing core 445-b (e.g., a gold core) for higher capabilities (e.g., faster processing). During this flow switch across processing cores 445, the data packets 415 may become out-of-order (e.g., if processing of previous packets on previous core is not completed before starting new packets on new core). In some other examples, some routes (e.g., data pipes) for data movement between a modem and a host may be faster than other routes, which may also result in out of sequence data packets.

As an illustrative example, at 430, packets P1, P2, and P3 may be routed to a processing core 445-a, and, at 435 (e.g., in parallel with 430), packets P4, P5, and P6 may be routed to a processing core 445-b. The processing core 445-b may process the packets P4, P5, and P6 faster than the processing core 445-a processes the packets P1, P2, and P3. As a result, at 450, the packets P4, P5, and P6 may arrive at a protocol stack 460 (e.g., TCP stack, IP stack) before the packets P1, P2, and P3 at 455. In some examples (e.g., in TCP or other lossless protocols), based on the packets arriving out-of-order at the protocol stack 460, the device 405-b may generate and transmit (e.g., via the communication link 410-b) multiple (e.g., three) duplicate ACK1 messages (e.g., indicating that P1 was not successfully received). The protocol stack 460 may then receive the out-of-order packets P1, P2, and P3 (e.g., within a time duration less than an RTT), and accordingly, the device 405-b may generate and transmit a pure (e.g., valid) ACK message, ACK7 (e.g., indicating successful receipt of all packets P1-P6).

However, even though the each of the data packets 415 were successfully received at the device 405-b, the transmitted duplicate ACK messages (e.g., ACK1, ACK1, ACK1) may have already triggered a retransmission (e.g., or multiple retransmissions) of packet P1. Additionally, the duplicate ACK messages may have triggered window scaling at the device 405-a, which may result in reduced throughput and lower performance. Thus, duplicate ACK messages are associated with out-of-order packets may cause excessive (e.g., unnecessary) use of communication resources and decreased overall system efficiency (e.g., for lossless transport protocols).

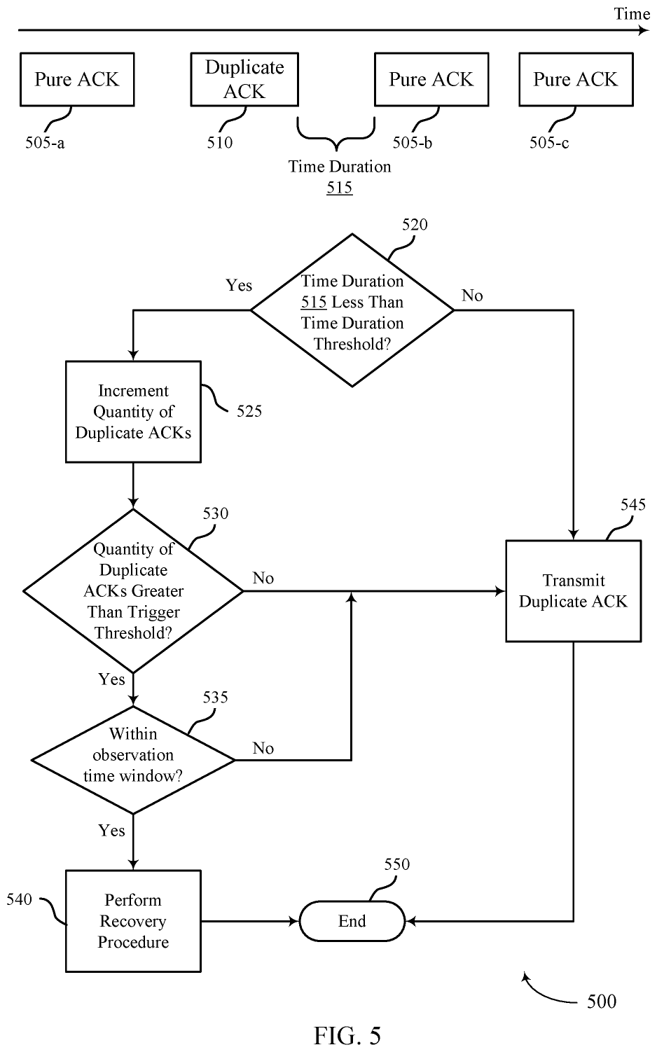

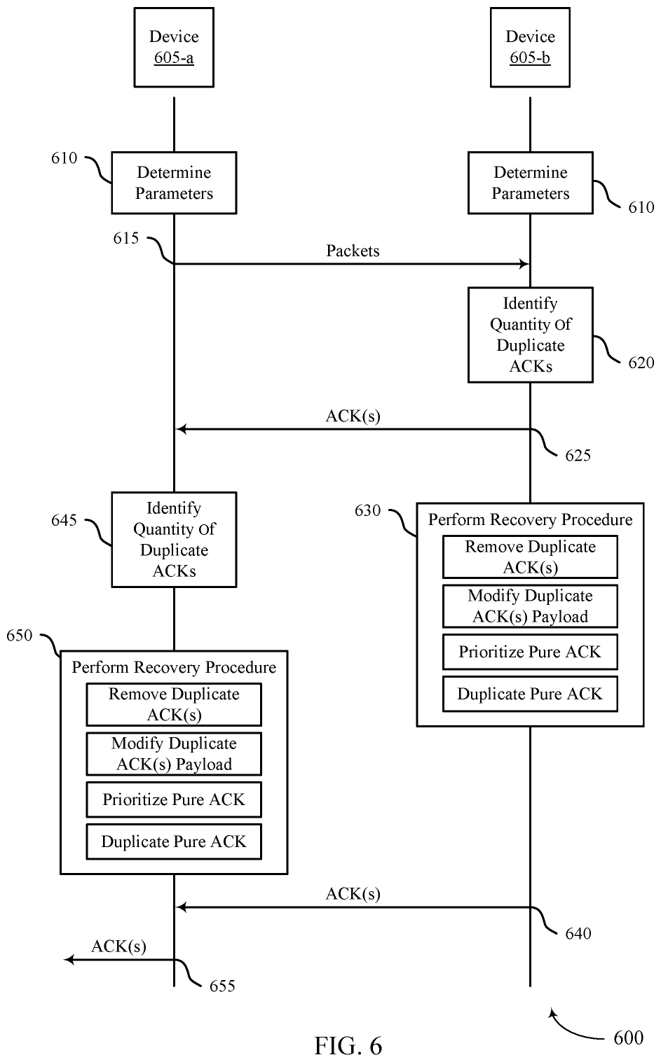

According to aspects herein, a device 405 may identify duplicate ACK messages that are associated with out-of-order data packets (e.g., may identify short-lived duplicate ACK messages). For example, a device 405 may identify a quantity of occurrences that a time duration between a duplicate ACK message and a pure ACK message satisfies (e.g., is within) a time duration threshold (e.g., an RTT, an end-to-end (E2E) RTT, an OTA time). Based on the quantity of occurrences satisfying a trigger threshold (e.g., a trigger quantity), the device 405 may be able to perform one or more recovery procedures to increase overall system efficiency (e.g., for lossless transport protocols). For example, a device 405 may removing duplicate ACK messages (e.g., ACK1) from a buffer at the device 305, modifying a payload for the duplicate ACK messages such that the duplicate ACK messages are discarded by a device 405 receiving the ACK messages, prioritizing transmission of pure ACK messages, among other techniques described herein. Such techniques may be described in further detail including with reference to FIGS. 5 and 6.

FIG. 5 shows an example of a flowchart 500 that supports duplicate ACK message reduction procedures in accordance with one or more aspects of the present disclosure. In some examples, the flowchart 500 may be implemented by the wireless communications system 100, the network architecture 200, the wireless communications system 300, and the wireless communications system 400. For example, a device 305, a device 405, or some other device described herein, may utilize aspects of the flowchart 500 to identify and compensate for redundant (e.g., short-lived) duplicate ACK messages to reduce signaling overhead and increase overall efficiency. In the following description of the flowchart 500, the operations may be performed in a different order than the order shown, or other operations may be added or removed from the flowchart 500. For example, some operations may also be left out of flowchart 500, or may be performed in different orders or at different times.

FIG. 5 includes an illustrative example of ACK messages (e.g., pure ACK messages 505 and duplicate ACK messages 510) on a time axis. Pure ACK messages 505 (e.g., pure ACK message 505-a, pure ACK message 505-b, pure ACK message 505-c) may indicate a successful receipt of a data packet in accordance with an ordered sequence (e.g., a data packet received in order). Duplicate ACK messages 510 may indicate that an expected packet (e.g., expected in accordance with an ordered sequence of data packets) was not received and may request retransmission of the expected data packet.

In some examples, a device (e.g., a wireless communications device, a device 305, a device 405) may operate according to one or more transport protocols (e.g., TCP over NG-U link using GTP-U protocol (UDP/IP)) and may generate and transmit duplicate ACK messages 510 to recover lost packets, which may not otherwise be received without the duplicate ACK messages 510 (e.g., without a request for retransmission). However, some duplicate ACK messages 510 may be generated for packets that are not lost but are received out-of-order (e.g., short-lived duplicate ACK messages). That is, the out-of-order packets may arrive after a relatively short time (e.g., shorter than an RTT), such that a retransmission of such packets may be redundant and may excessively increase overhead and increase latency.

To support more efficient utilization of communication resources (e.g., frequency bandwidth, time resources, power resources), a device may identify one or more duplicate ACK messages 510 associated with out-of-order packets (e.g., may identify opportunities for recovery). The device may use one or more trigger conditions based on identifying the one or more duplicate ACK messages 510 to apply a procedure (e.g., a recovery solution) to reduce the duplicate ACK messages 510 (e.g., redundant duplicate ACK messages, short-lived duplicate ACK messages). In some examples, such methods may apply in a modem (e.g., of a wireless device) before transmission of duplicate ACK messages 510 (e.g., in an uplink wireless interface) or after reception of duplicate ACK messages 510 before transfer to host (e.g., in a downlink wireless interface). Accordingly, a device may reduce duplicate ACK messages 510 and mitigate adverse effects (e.g., increased latency, decreased throughput) in a wireless communication system associated with (e.g., redundant, short-lived) duplicate ACK messages 510.

In some examples, to identify one or more duplicate ACK messages 510 associated with out-of-order packets (e.g., to identify opportunities for recovery), a device may identify a time duration 515. The time duration 515 may be a duration between generation of a duplicate ACK message 510 and generation of a subsequent pure ACK message 505-b (e.g., a time duration between any duplicate ACK message 510 and a subsequent pure ACK message 505). In some examples, the pure ACK message 505-b may indicate successful receipt of a same packet as the duplicate ACK message 510 as well as successful receipt of one or more subsequent packets in the sequence of data packets. The device may compare the time duration 515 to a time duration threshold (e.g., an E2E RTT, an OTA RTT, or both) to identify the duplicate ACK message 510 (e.g., whether the duplicate ACK message 510 is short-lived).

The device may identify the time duration threshold (e.g., a parameter T_{short_ack}) based on one or more channel condition metrics of a wireless channel (e.g., radio conditions, used for communicating data packets). For example, the channel conditions metrics may include a pathloss metric, an RTT (e.g., an L2 RTT, an E2E RTT), a block error rate (BLER) (e.g., an L1 BLER, an L2 BLER), or any combination thereof. For example, a device (e.g., a receiver) may estimate an E2E RTT (e.g., E2E may be known to a transmitter), and the time duration threshold may be based on the E2E RTT. Additionally, or alternatively, a device may estimate an OTA RTT based on a duration between an L2 or RLC level packet transmission to an ACK message or based on a duration between a HARQ level transmission to an ACK message, and the time duration threshold may be based on the OTA RTT.

At 520, a procedure may begin with a comparison (e.g., by the device) of the time duration 515 to the time duration threshold. In some examples, the time duration 515 (e.g., between the duplicate ACK message 510 ACK and the pure ACK message 505-b) may be less than the time duration threshold (e.g., less than E2E RTT, less than OTA time), which be indicate that one or more data packets was received out-of-order but eventually arrived (e.g., arrived later than expected). If the time duration 515 is not less than the time duration threshold (e.g., the duplicate ACK message may not be associated with an out-of-order packet), the procedure may proceed to 545, where the device may transmit the duplicate ACK message 510 (e.g., via a data connection), and the procedure may end at 550.

If the time duration 515 is less than the time duration threshold, the procedure may continue to 525 to potentially reduce (e.g., optimize) duplicate ACK messages 510 (e.g., short-lived duplicate ACK messages). At 525 the device may increment a quantity of duplicate ACK messages 510 (e.g., a quantity of duplicate ACK messages identified as short-lived duplicate ACKs). At 530, the device may determine whether the quantity of duplicate ACK messages 510 satisfies a trigger threshold (e.g., a trigger quantity threshold value, a parameter N). If the trigger threshold is not satisfied, the procedure may proceed to 545 to transmit the duplicate ACK message 510, and the procedure may end at 550. If the trigger threshold is satisfied, the procedure may continue to 535 where the device may determine whether the trigger threshold was satisfied within an observation time window (e.g., a parameter T_{duration}). If the trigger threshold was not satisfied within the observation time window, the procedure may proceed to 545 to transmit the duplicate ACK message 510, and the procedure may end at 550.

That is, the device may determine (e.g., from 520 to 535) whether a quantity of occurrences that a time duration 515 is less than the time duration threshold satisfies a trigger quantity within the observation time window. In some examples, a device may determine a duration for the observation time window, the time duration threshold, and the trigger threshold based on one or more channel condition metrics of the wireless channel, radio technology characteristics, protocol related configurations, or any combination thereof, used for communication of the packets via the wireless channel. The one or more channel condition metrics may include a pathloss metric, an RTT (e.g., an L2 RTT, an E2E RTT, a BLER (e.g., an L1 BLER, an L2 BLER), other channel condition metrics, or any combination thereof. The radio technology characteristics may include a radio access technology (RAT) type used for communication of the packets via the wireless channel, a sub-carrier spacing (SCS) used for communication of the packets via the wireless channel, a frequency band used for communication of the packets via the wireless channel, other radio technology characteristics, or any combination thereof. The protocol related configuration (e.g., TCP variations, TCP format. TCP protocol) may include protocol algorithm configurations (e.g., TCP algorithm), congestion management configurations, buffering mechanisms, windowing mechanisms, other protocol related configurations, or any combination thereof, used for communication of the packets via the wireless channel.

If the trigger threshold was satisfied within the observation time window the procedure may proceed to 540, where the device may perform a recovery procedure (e.g., on pure ACK message 505 detection after short-lived duplicate ACK message 510). In some examples, the recovery procedure may include removing one or more ACK messages identified as being a duplicate from a transmission buffer or a receive buffer. In other words, the recovery procedure may include removing duplicate ACK messages 510 related to a particular flow that are pending in a transmitter (e.g., in modem L2 buffers or other buffers which are yet to be transmitted).

Additionally, or alternatively, the recovery procedure may include transmitting a retransmission of a duplicate ACK message having a first payload that is different than a second payload communicated in a prior transmission of the duplicate ACK message 510, such that the first payload may fail to be decoded (e.g., may fail to satisfy a checksum or error check procedure associated with the duplicate ACK message 510) when received. That is, if some duplicate ACK messages 510 are pending (e.g., in an RLC transmit queue) for retransmissions, the recovery procedure may include modifying the contents of the payload (e.g., RLC payload) to ensure that the received ACK message is discarded (e.g., at the network) due to IP checksum failure (e.g., though RLC/PDCP sequence number continuity).

Additionally, or alternatively, the recovery procedure may include prioritizing a transmission of a pure ACK message 505 (e.g., pure ACK message 505-b) associated with a duplicate ACK message 510 (e.g., the pure ACK message 505 is prioritized over transmission of the duplicate ACK message 510) via a radio bearer, a logical channel, or both. That is, a flow specific to a pure ACK message may be prioritized over other flows (e.g., on a same radio bearer, flows mapped on the same DRB or logic channel). Additionally, a logical channel associated with transmission of a pure ACK may be prioritized over other logical channels (e.g., overriding the logical channel prioritization (LCP) rules).

Additionally, or alternatively, the recovery procedure may include transmitting a pure ACK message 505 over a first radio link, a first component carrier, or both, and retransmitting the pure ACK message 505 over a second radio link, a second component carrier, or both. That is, a logical channel transmission may be duplicated over multiple radio links (e.g., in case of dual-connectivity), over multiple component carriers (e.g., in case of carrier aggregation), or both (e.g., to increase a likelihood of receipt and reduce latency to transmit a pure ACK message 505 for a flow). After performing the recovery procedure, and the procedure may end at 550.

FIG. 6 shows an example of a process flow 600 that supports duplicate ACK message reduction procedures in accordance with one or more aspects of the present disclosure. In some examples, process flow 600 may implement or be implemented by aspects of the wireless communications system 100, the network architecture 200, the wireless communications system 300, the wireless communications system 400, and the flowchart 500. For example, the process flow 600 may support techniques to identify duplicate ACK messages and preform a recovery procedure to avoid adverse effects to a wireless communication system. The process flow 600 may include a device 605-a and device 605-b, which may be examples of corresponding devices herein, including with reference to FIGS. 1 through 5. In some examples, communications from the device 605-a to the device 605-b may occur in a downlink communication interface and communications from the device 605-b to the device 605-a may occur in an uplink communication interface.

In the following description of process flow 600, the operations between the device 605-a and the device 605-b may be transmitted in a different order than the order shown, or other operations may be added or removed from the process flow 600. For example, some operations may also be left out of process flow 600, or may be performed in different orders or at different times. Further, although some operations or signaling may be shown to occur at different times for discussion purposes, these operations may actually occur at the same time. Although the device 605-a and the device 605-b are shown performing the operations of process flow 600, some aspects of some operations may also be performed by one or more other wireless or network devices.

At 610, the device 605-a and the device 605-b may determine one or more parameters associated with techniques herein. For example, the one or more parameters may include a duration of an observation time window (e.g., a parameter T_{duration}), a time duration threshold (e.g., a parameter T_{short_ack}), a trigger threshold (e.g., a trigger quantity threshold value, a parameter N), or any combination thereof. In some examples, the parameters may be based on one or more channel condition metrics of the wireless channel. In some examples, the one or more channel condition metrics of the wireless channel may include a pathloss metric, an RTT, an L2 RTT, an E2E RTT, a BLER, an L1 BLER, an L2 BLER, or any combination thereof. For example, the time duration threshold may be based on (e.g., or the same as) an E2E RTT for a transmission of at least one data packet of multiple data packets from a transmitter (e.g., the device 605-a) to a receiver (e.g., the device 605-b). In some examples, a network entity, the device 605-a, the device 605-b, or any combination thereof, may transmit a control message to indicate values for the one or more parameters.

Additionally, or alternatively, one or more of the duration of the observation time window, the time duration threshold, or the trigger threshold may be based on a RAT type of the wireless device, an SCS, a frequency band, or a combination thereof used to communicate multiple data packets. Additionally, or alternatively, one or more of the duration of the observation time window, the time duration threshold, or the trigger threshold may be based on a configuration of a communication protocol (e.g., TCP flavor) used for communicating the multiple data packets via the data connection.

At 615, the device 605-b may receive (e.g., from the device 605-a) multiple data packets via a data connection established via a wireless channel. In some examples, the multiple data packets may be a sequence of data packets (e.g., in an ordered sequence, using sequential sequence numbers) communicated via the data connection. In some examples, the device 605-b may receive the multiple data packets in accordance with the sequence (e.g., in-order) and may forward the multiple data packets to a protocol layer stack (e.g., TCP stack, IP stack) for generating ACK messages in a different sequential order (e.g., out-of-order).

At 620, the device 605-b may identify a quantity of duplicate ACK messages that are generated (e.g., in a transmit buffer) for the multiple data packets. In some examples, a first ACK message may be identified as being a duplicate ACK message (e.g., a short-lived duplicate ACK) based on a second ACK message (e.g., a pure ACK message) indicating successful receipt of a same packet as the first ACK message and successful receipt of one or more subsequent packets in the sequence of data packets. Additionally, the first ACK message may identified as being the duplicate ACK message based on the second ACK message being generated within a time duration threshold (e.g., determined at 610) of the first ACK message. In some examples, identifying the quantity of duplicate ACK messages may include identifying the quantity of duplicate ACK messages during the observation time window, where the duration of the observation time window is based on one or more channel condition metrics of the wireless channel (e.g., determined at 610).

At 625, the device 605-b may transmit one or more ACK messages to the device 605-a. For example, the device 605-b may not identify the quantity of duplicate ACK messages or may not perform a recovery procedure to reduce duplicate ACK messages. Accordingly, the device 605-b may transmit the ACK messages to the device 605-a, and the device 605-a may perform the recovery procedure. In some examples, both the device 605-a and the device 605-b may perform the recovery procedure.

At 630, the device 605-b may perform a duplicate ACK recovery procedure based on the quantity of duplicate ACK messages satisfying a trigger threshold (e.g., within an observation time window duration). In some examples, the duplicate ACK recovery procedure may include removing one or more ACK messages identified as being a duplicate from a transmission buffer. Additionally, or alternatively, the device 605-b may transmit a retransmission of a duplicate ACK message having a first payload that is different than a second payload communicated in a prior transmission of the duplicate ACK message. That is, the device 605-b may modify a payload associated with one or more duplicate ACK messages. In some examples, the first payload (e.g., the modified payload) may fail to satisfy a checksum or error check procedure associated with the duplicate ACK message (e.g., at a receiving device).

Additionally, or alternatively, the duplicate ACK recovery procedure may indicate that transmission of the second ACK message (e.g., the pure ACK) is prioritized over transmission of the first ACK message (e.g., the duplicate ACK) or other messages transmitted via a radio bearer, a logical channel, or both. Additionally, or alternatively, the device 605-b may transmit the second ACK message over a first radio link, a first component carrier, or both and may transmit the second ACK message over a second radio link, a second component carrier, or both (e.g., a pure ACK may be duplicated over multiple radio links and/or multiple component carriers).

At 640, the device 605-b may transmit one or more ACK messages (e.g., including the second ACK message) to the device 605-a via the data connection. In some examples, the device 605-b may transmit the one or more ACK messages in accordance with performing the duplicate ACK recovery procedure (e.g., some ACK messages may have been removed, modified, prioritized, duplicated, or the like). For example, the device 605-b may transmit, and the device 605-a may receive, the second ACK message over a first radio link, a first component carrier, as well as over a second radio link, a second component carrier, or both.

At 645, the device 605-a may additionally, or alternatively, identify the quantity of duplicate ACK messages that are received (e.g., received at 625, in a receive buffer) for the multiple data packets. For example, the device 305-a may identify a first ACK message (e.g., a first received ACK message) as being a duplicate ACK message based on receiving a second ACK message indicating successful receipt of a same packet as the first ACK message and successful receipt of one or more subsequent packets in the sequence of data packets. In some examples, the device 305-a may additionally identify a first ACK message as being a duplicate ACK message based on the second ACK message being received within a time duration threshold of the first ACK message. In some examples, identifying the quantity of duplicate ACK messages may include identifying the quantity of duplicate ACK messages during an observation time window, where a duration of the observation time window may be based on one or more channel condition metrics of the wireless channel (e.g., determined at 610).

At 650, the device 605-a may perform a duplicate ACK recovery procedure based on the quantity of duplicate ACK messages (e.g., identified at 645) satisfying a trigger threshold. In some examples, the duplicate ACK recovery procedure may include removing one or more ACK messages identified as being a duplicate from a receive buffer (e.g., prior to transferring to a host or another device). Additionally, or alternatively, the device 605-a may forward (e.g., transfer) another instance of a duplicate ACK message having a first payload that is different than a second payload communicated in a prior reception of the duplicate ACK message. That is, the device 605-a may modify a payload associated with one or more duplicate ACK messages prior to forwarding. In some examples, the first payload (e.g., the modified payload) may fail to satisfy a checksum or error check procedure associated with the duplicate ACK message (e.g., at the host or other device). Additionally, or alternatively, the duplicate ACK recovery procedure may indicate forwarding of the second ACK message is prioritized over forwarding of the first ACK message (e.g., via a radio bearer, a logical channel, or both), or the second ACK message may be duplicated for forwarding, or both.

At 655, the device 605-a may forward one or more ACK messages to another device (not shown) such as a host device (e.g., an application server), a UE, a network node (e.g., a core network node), or some other network device. For example, the device 605-a may forward the one or more ACK messages in accordance with the recovery procedure performed at 650, the recovery procedure at 630 (e.g., via the received ACK message(s) at 640), or both.

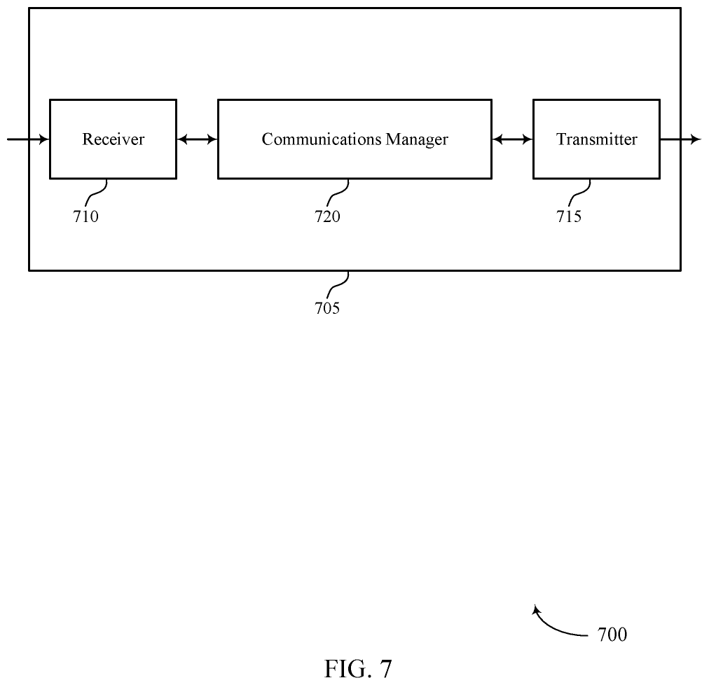

FIG. 7 shows a block diagram 700 of a device 705 that supports duplicate ACK message reduction procedures in accordance with one or more aspects of the present disclosure. The device 705 may be an example of aspects of a wireless device as described herein. The device 705 may include a receiver 710, a transmitter 715, and a communications manager 720. The device 705, or one or more components of the device 705 (e.g., the receiver 710, the transmitter 715, and the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to duplicate ACK message reduction procedures). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to duplicate ACK message reduction procedures). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of duplicate ACK message reduction procedures as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor. If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for transmitting or receiving a set of multiple data packets via a data connection established via a wireless channel, the set of multiple data packets being a sequence of data packets communicated via the data connection. The communications manager 720 is capable of, configured to, or operable to support a means for identifying a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message. The communications manager 720 is capable of, configured to, or operable to support a means for performing a duplicate ACK recovery procedure based on the quantity of duplicate ACK messages satisfying a trigger threshold.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

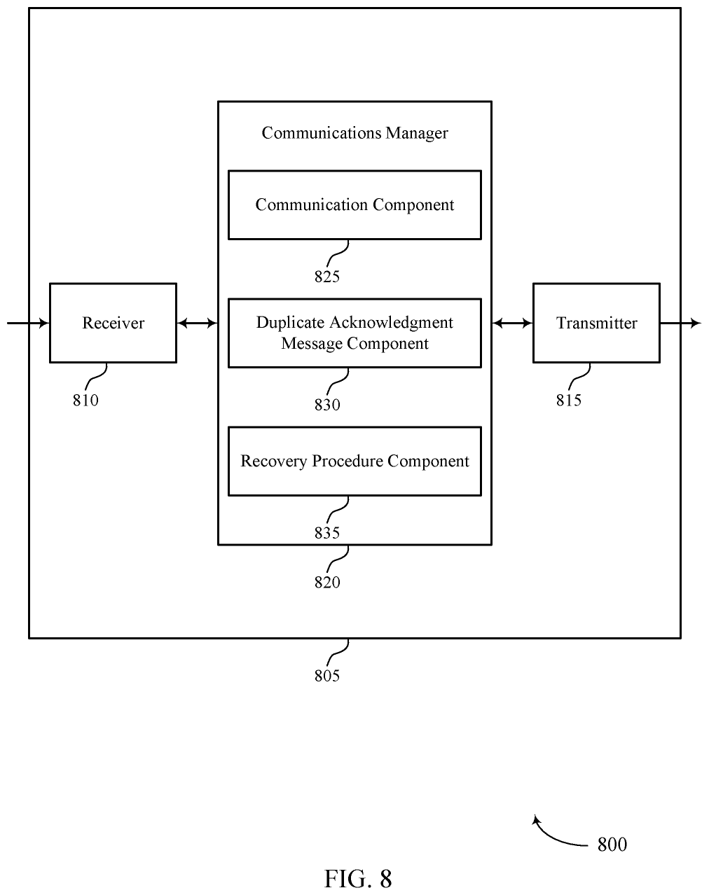

FIG. 8 shows a block diagram 800 of a device 805 that supports duplicate ACK message reduction procedures in accordance with one or more aspects of the present disclosure. The device 805 may be an example of aspects of a device 705 as described herein. The device 805 may include a receiver 810, a transmitter 815, and a communications manager 820. The device 805, or one or more components of the device 805 (e.g., the receiver 810, the transmitter 815, and the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to duplicate ACK message reduction procedures). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to duplicate ACK message reduction procedures). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of duplicate ACK message reduction procedures as described herein. For example, the communications manager 820 may include a communication component 825, a duplicate ACK message component 830, a recovery procedure component 835, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The communication component 825 is capable of, configured to, or operable to support a means for transmitting or receiving a set of multiple data packets via a data connection established via a wireless channel, the set of multiple data packets being a sequence of data packets communicated via the data connection. The duplicate ACK message component 830 is capable of, configured to, or operable to support a means for identifying a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message. The recovery procedure component 835 is capable of, configured to, or operable to support a means for performing a duplicate ACK recovery procedure based on the quantity of duplicate ACK messages satisfying a trigger threshold.

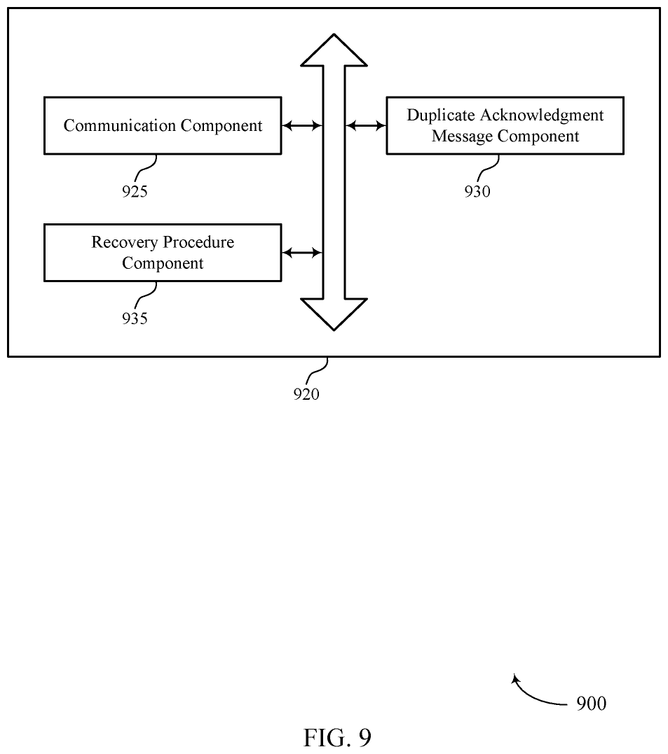

FIG. 9 shows a block diagram 900 of a communications manager 920 that supports duplicate ACK message reduction procedures in accordance with one or more aspects of the present disclosure. The communications manager 920 may be an example of aspects of a communications manager 720, a communications manager 820, or both, as described herein. The communications manager 920, or various components thereof, may be an example of means for performing various aspects of duplicate ACK message reduction procedures as described herein. For example, the communications manager 920 may include a communication component 925, a duplicate ACK message component 930, a recovery procedure component 935, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The communication component 925 is capable of, configured to, or operable to support a means for transmitting or receiving a set of multiple data packets via a data connection established via a wireless channel, the set of multiple data packets being a sequence of data packets communicated via the data connection. The duplicate ACK message component 930 is capable of, configured to, or operable to support a means for identifying a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message. The recovery procedure component 935 is capable of, configured to, or operable to support a means for performing a duplicate ACK recovery procedure based on the quantity of duplicate ACK messages satisfying a trigger threshold.

In some examples, one or more of the time duration threshold or the trigger threshold is based on one or more channel condition metrics of the wireless channel. In some examples, the one or more channel condition metrics of the wireless channel includes a pathloss metric, an RTT, an L2 RTT, an E2E RTT, a BLER, an L1 BLER, an L2 BLER, or any combination thereof.

In some examples, one or more of the time duration threshold or the trigger threshold is based on a RAT type of the wireless device used to communicate the set of multiple data packets, an SCS used to communicate the set of multiple data packets, a frequency band used to communicate the set of multiple data packets, or any combination thereof.

In some examples, one or more of the time duration threshold or the trigger threshold is based on a configuration of a communication protocol used for communicating the set of multiple data packets via the data connection.

In some examples, the communication component 925 is capable of, configured to, or operable to support a means for transmitting or receiving the second ACK message via the data connection. In some examples, the set of multiple data packets are received by the wireless device in accordance with the sequence and forwarded to a protocol layer stack for generating ACK messages in a different sequential order. In some examples, the time duration threshold is based on an E2E RTT for a transmission of at least one data packet of the set of multiple data packets from a transmitter to the wireless device.

In some examples, to support duplicate ACK recovery procedure, the recovery procedure component 935 is capable of, configured to, or operable to support a means for removing one or more ACK messages identified as being a duplicate from a transmission buffer.

In some examples, to support duplicate ACK recovery procedure, the recovery procedure component 935 is capable of, configured to, or operable to support a means for removing one or more ACK messages identified as being a duplicate from a receive buffer.

In some examples, to support duplicate ACK recovery procedure, the recovery procedure component 935 is capable of, configured to, or operable to support a means for transmitting a retransmission of a duplicate ACK message having a first payload that is different than a second payload communicated in a prior transmission of the duplicate ACK message, where the first payload fails to satisfy a checksum or error check procedure associated with the duplicate ACK message.

In some examples, the duplicate ACK recovery procedure indicates that transmission of the second ACK message is prioritized over transmission of the first ACK message via a radio bearer, a logical channel, or both.

In some examples, to support duplicate ACK recovery procedure, the recovery procedure component 935 is capable of, configured to, or operable to support a means for transmitting or receiving the second ACK message over a first radio link, a first component carrier, or both. In some examples, to support duplicate ACK recovery procedure, the recovery procedure component 935 is capable of, configured to, or operable to support a means for transmitting or receiving the second ACK message over a second radio link, a second component carrier, or both.

In some examples, to support identifying the quantity of duplicate ACK messages, the duplicate ACK message component 930 is capable of, configured to, or operable to support a means for identifying the quantity of duplicate ACK messages during an observation time window, where a duration of the observation time window is based on one or more channel condition metrics of the wireless channel. In some examples, the one or more channel condition metrics of the wireless channel includes a pathloss metric, an RTT, an L2 RTT, an E2E RTT, a BLER, an L1 BLER, an L2 BLER, or any combination thereof.

In some examples, the duration of the observation time window is based on a RAT type of the wireless device used to communicate the set of multiple data packets, an SCS used to communicate the set of multiple data packets, a frequency band used to communicate the set of multiple data packets, or any combination thereof. In some examples, the duration of the observation time window is based on a configuration of a communication protocol used for communicating the set of multiple data packets via the data connection.

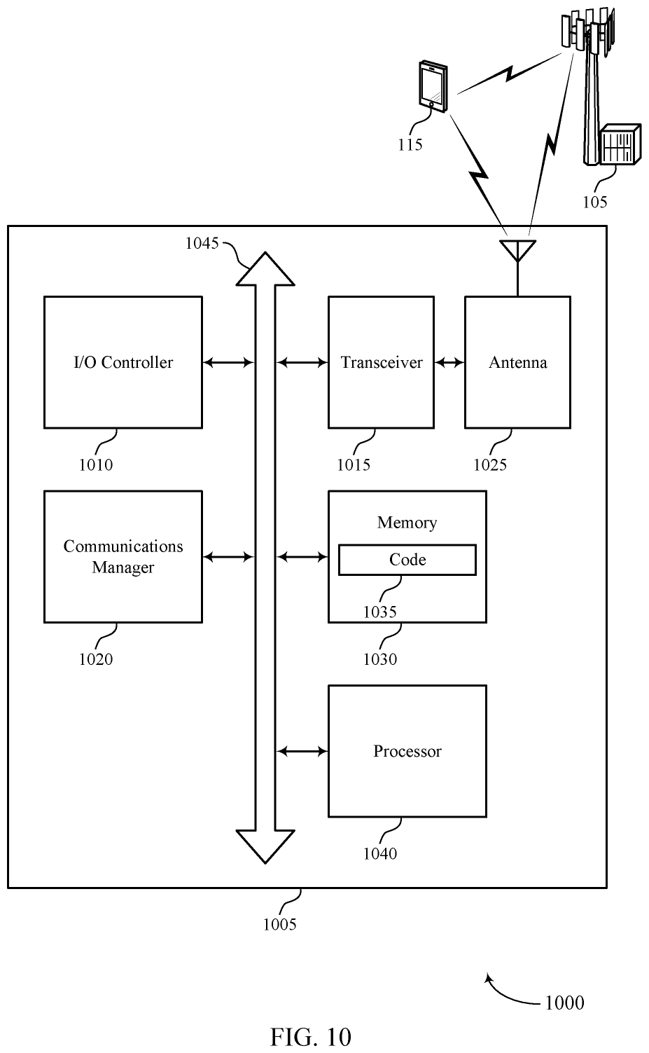

FIG. 10 shows a diagram of a system 1000 including a device 1005 that supports duplicate ACK message reduction procedures in accordance with one or more aspects of the present disclosure. The device 1005 may be an example of or include the components of a device 705, a device 805, or a wireless device as described herein. The device 1005 may include components for bi-directional voice and data communications including components for transmitting and receiving communications, such as a communications manager 1020, an I/O controller 1010, a transceiver 1015, an antenna 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include RAM and ROM. The at least one memory 1030 may store computer-readable, computer-executable code 1035 including instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may contain, among other things, a BIOS which may control basic hardware or software operation such as the interaction with peripheral components or devices.

The at least one processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting duplicate ACK message reduction procedures). For example, the device 1005 or a component of the device 1005 may include at least one processor 1040 and at least one memory 1030 coupled with or to the at least one processor 1040, the at least one processor 1040 and at least one memory 1030 configured to perform various functions described herein. In some examples, the at least one processor 1040 may include multiple processors and the at least one memory 1030 may include multiple memories. One or more of the multiple processors may be coupled with one or more of the multiple memories, which may, individually or collectively, be configured to perform various functions herein.

The communications manager 1020 may support wireless communications in accordance with examples as disclosed herein. For example, the communications manager 1020 is capable of, configured to, or operable to support a means for transmitting or receiving a set of multiple data packets via a data connection established via a wireless channel, the set of multiple data packets being a sequence of data packets communicated via the data connection. The communications manager 1020 is capable of, configured to, or operable to support a means for identifying a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message. The communications manager 1020 is capable of, configured to, or operable to support a means for performing a duplicate ACK recovery procedure based on the quantity of duplicate ACK messages satisfying a trigger threshold.

By including or configuring the communications manager 1020 in accordance with examples as described herein, the device 1005 may support techniques for reduced latency, improved user experience related to reduced processing, reduced power consumption, more efficient utilization of communication resources, improved coordination between devices, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of duplicate ACK message reduction procedures as described herein, or the at least one processor 1040 and the at least one memory 1030 may be otherwise configured to, individually or collectively, perform or support such operations.

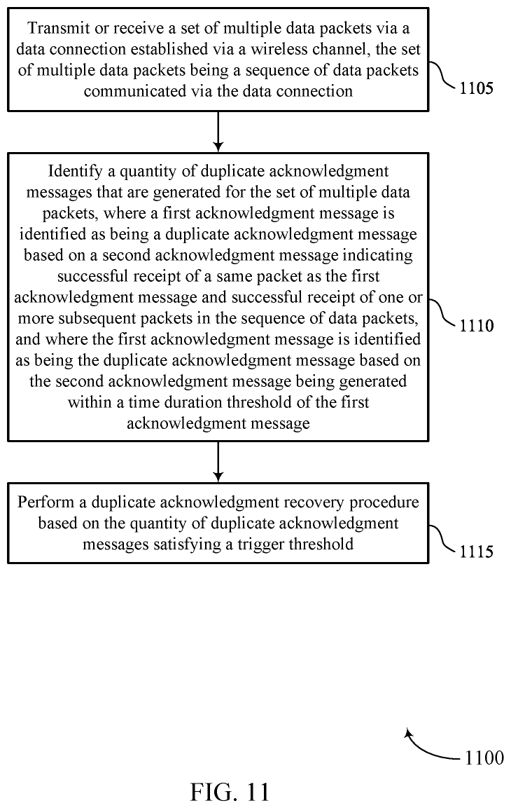

FIG. 11 shows a flowchart illustrating a method 1100 that supports duplicate ACK message reduction procedures in accordance with aspects of the present disclosure. The operations of the method 1100 may be implemented by a wireless device or its components as described herein. For example, the operations of the method 1100 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1105, the method may include transmitting or receiving a set of multiple data packets via a data connection established via a wireless channel, the set of multiple data packets being a sequence of data packets communicated via the data connection. The operations of block 1105 may be performed in accordance with examples as disclosed herein. In some examples, aspects of the operations of 1105 may be performed by a communication component 925 as described with reference to FIG. 9.

At 1110, the method may include identifying a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message. The operations of block 1110 may be performed in accordance with examples as disclosed herein. In some examples, aspects of the operations of 1110 may be performed by a duplicate ACK message component 930 as described with reference to FIG. 9.

At 1115, the method may include performing a duplicate ACK recovery procedure based on the quantity of duplicate ACK messages satisfying a trigger threshold. The operations of block 1115 may be performed in accordance with examples as disclosed herein. In some examples, aspects of the operations of 1115 may be performed by a recovery procedure component 935 as described with reference to FIG. 9.

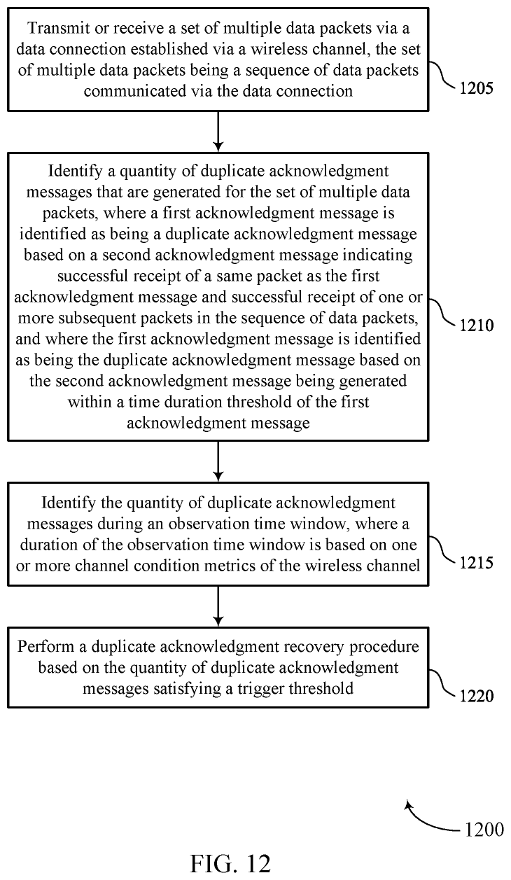

FIG. 12 shows a flowchart illustrating a method 1200 that supports duplicate ACK message reduction procedures in accordance with aspects of the present disclosure. The operations of the method 1200 may be implemented by a wireless device or its components as described herein. For example, the operations of the method 1200 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1205, the method may include transmitting or receiving a set of multiple data packets via a data connection established via a wireless channel, the set of multiple data packets being a sequence of data packets communicated via the data connection. The operations of block 1205 may be performed in accordance with examples as disclosed herein. In some examples, aspects of the operations of 1205 may be performed by a communication component 925 as described with reference to FIG. 9.

At 1210, the method may include identifying a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message. The operations of block 1210 may be performed in accordance with examples as disclosed herein. In some examples, aspects of the operations of 1210 may be performed by a duplicate ACK message component 930 as described with reference to FIG. 9.

At 1215, the method may include identifying the quantity of duplicate ACK messages during an observation time window, where a duration of the observation time window is based on one or more channel condition metrics of the wireless channel. The operations of block 1215 may be performed in accordance with examples as disclosed herein. In some examples, aspects of the operations of 1215 may be performed by a duplicate ACK message component 930 as described with reference to FIG. 9.

At 1220, the method may include performing a duplicate ACK recovery procedure based on the quantity of duplicate ACK messages satisfying a trigger threshold. The operations of block 1220 may be performed in accordance with examples as disclosed herein. In some examples, aspects of the operations of 1220 may be performed by a recovery procedure component 935 as described with reference to FIG. 9.

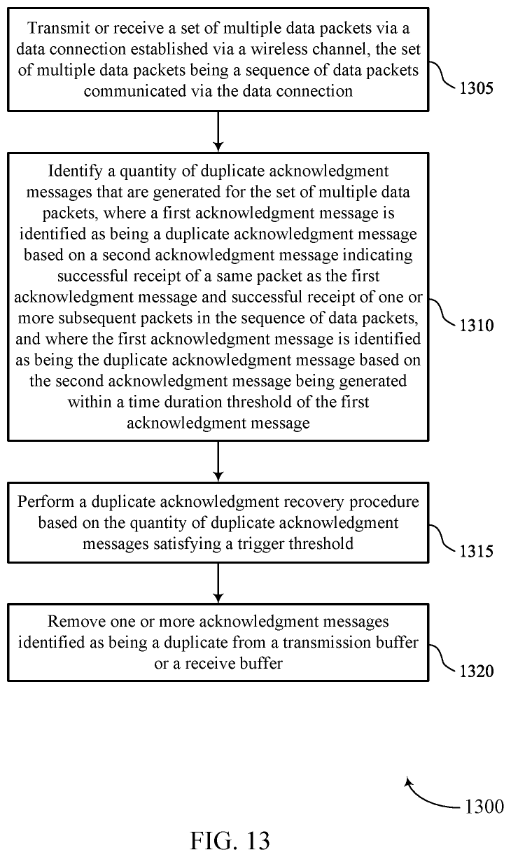

FIG. 13 shows a flowchart illustrating a method 1300 that supports duplicate ACK message reduction procedures in accordance with aspects of the present disclosure. The operations of the method 1300 may be implemented by a wireless device or its components as described herein. For example, the operations of the method 1300 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1305, the method may include transmitting or receiving a set of multiple data packets via a data connection established via a wireless channel, the set of multiple data packets being a sequence of data packets communicated via the data connection. The operations of block 1305 may be performed in accordance with examples as disclosed herein. In some examples, aspects of the operations of 1305 may be performed by a communication component 925 as described with reference to FIG. 9.

At 1310, the method may include identifying a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message. The operations of block 1310 may be performed in accordance with examples as disclosed herein. In some examples, aspects of the operations of 1310 may be performed by a duplicate ACK message component 930 as described with reference to FIG. 9.

At 1315, the method may include performing a duplicate ACK recovery procedure based on the quantity of duplicate ACK messages satisfying a trigger threshold. The operations of block 1315 may be performed in accordance with examples as disclosed herein. In some examples, aspects of the operations of 1315 may be performed by a recovery procedure component 935 as described with reference to FIG. 9.

At 1320, the method may include removing one or more ACK messages identified as being a duplicate from a transmission buffer or a receive buffer (e.g., or both). The operations of block 1320 may be performed in accordance with examples as disclosed herein. In some examples, aspects of the operations of 1320 may be performed by a recovery procedure component 935 as described with reference to FIG. 9.

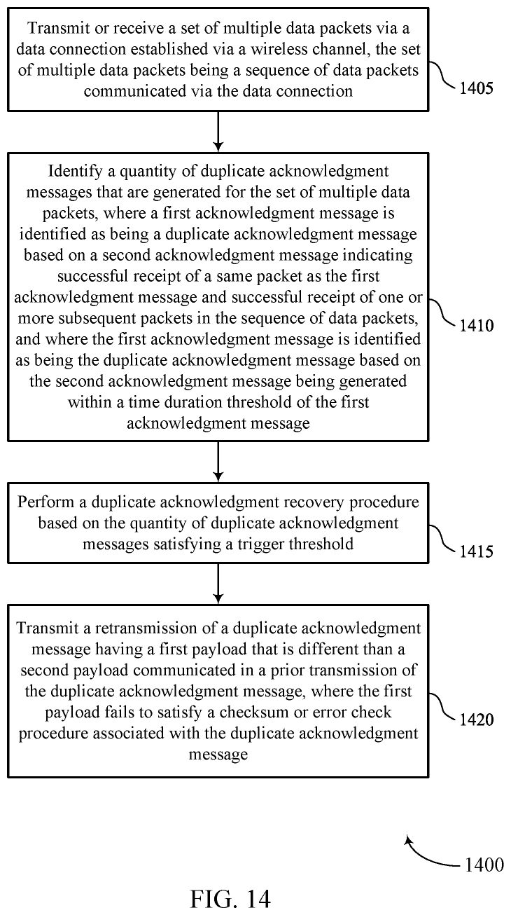

FIG. 14 shows a flowchart illustrating a method 1400 that supports duplicate ACK message reduction procedures in accordance with aspects of the present disclosure. The operations of the method 1400 may be implemented by a wireless device or its components as described herein. For example, the operations of the method 1400 may be performed by a wireless device as described with reference to FIGS. 1 through 10. In some examples, a wireless device may execute a set of instructions to control the functional elements of the wireless device to perform the described functions. Additionally, or alternatively, the wireless device may perform aspects of the described functions using special-purpose hardware.

At 1405, the method may include transmitting or receiving a set of multiple data packets via a data connection established via a wireless channel, the set of multiple data packets being a sequence of data packets communicated via the data connection. The operations of block 1405 may be performed in accordance with examples as disclosed herein. In some examples, aspects of the operations of 1405 may be performed by a communication component 925 as described with reference to FIG. 9.

At 1410, the method may include identifying a quantity of duplicate ACK messages that are generated for the set of multiple data packets, where a first ACK message is identified as being a duplicate ACK message based on a second ACK message indicating successful receipt of a same packet as the first ACK message and successful receipt of one or more subsequent packets in the sequence of data packets, and where the first ACK message is identified as being the duplicate ACK message based on the second ACK message being generated within a time duration threshold of the first ACK message. The operations of block 1410 may be performed in accordance with examples as disclosed herein. In some examples, aspects of the operations of 1410 may be performed by a duplicate ACK message component 930 as described with reference to FIG. 9.

At 1415, the method may include performing a duplicate ACK recovery procedure based on the quantity of duplicate ACK messages satisfying a trigger threshold. The operations of block 1415 may be performed in accordance with examples as disclosed herein. In some examples, aspects of the operations of 1415 may be performed by a recovery procedure component 935 as described with reference to FIG. 9.

At 1420, the method may include transmitting (e.g., or receiving) a retransmission of a duplicate ACK message having a first payload that is different than a second payload communicated in a prior transmission of the duplicate ACK message, where the first payload fails to satisfy a checksum or error check procedure associated with the duplicate ACK message. The operations of block 1420 may be performed in accordance with examples as disclosed herein. In some examples, aspects of the operations of 1420 may be performed by a recovery procedure component 935 as described with reference to FIG. 9.

The following provides an overview of aspects of the present disclosure:

Aspect 1: A method for wireless communications at a wireless device, comprising: transmitting or receiving a plurality of data packets via a data connection established via a wireless channel, the plurality of data packets being a sequence of data packets communicated via the data connection; identifying a quantity of duplicate acknowledgment messages that are generated for the plurality of data packets, wherein a first acknowledgment message is identified as being a duplicate acknowledgment message based at least in part on a second acknowledgment message indicating successful receipt of a same packet as the first acknowledgment message and successful receipt of one or more subsequent packets in the sequence of data packets, and wherein the first acknowledgment message is identified as being the duplicate acknowledgment message based at least in part on the second acknowledgment message being generated within a time duration threshold of the first acknowledgment message; and performing a duplicate acknowledgment recovery procedure based at least in part on the quantity of duplicate acknowledgment messages satisfying a trigger threshold.

Aspect 2: The method of aspect 1, wherein one or more of the time duration threshold or the trigger threshold is based at least in part on one or more channel condition metrics of the wireless channel.

Aspect 3: The method of aspect 2, wherein the one or more channel condition metrics of the wireless channel comprises a pathloss metric, a round trip time, a layer two round trip time, an end-to-end round trip time, a block error rate, a layer one block error rate, a layer two block error rate, or any combination thereof.

Aspect 4: The method of any of aspects 1 through 3, wherein one or more of the time duration threshold or the trigger threshold is based at least in part on a radio access technology type of the wireless device used to communicate the plurality of data packets, a sub-carrier spacing used to communicate the plurality of data packets, a frequency band used to communicate the plurality of data packets, or any combination thereof.

Aspect 5: The method of any of aspects 1 through 4, wherein one or more of the time duration threshold or the trigger threshold is based at least in part on a configuration of a communication protocol used for communicating the plurality of data packets via the data connection.

Aspect 6: The method of any of aspects 1 through 5, further comprising: transmitting or receiving the second acknowledgment message via the data connection.

Aspect 7: The method of any of aspects 1 through 6, wherein the plurality of data packets are received by the wireless device in accordance with the sequence and forwarded to a protocol layer stack for generating acknowledgment messages in a different sequential order.

Aspect 8: The method of any of aspects 1 through 7, wherein the time duration threshold is based at least in part on an end-to-end round trip time for a transmission of at least one data packet of the plurality of data packets from a transmitter to the wireless device.

Aspect 9: The method of any of aspects 1 through 8, wherein the duplicate acknowledgment recovery procedure comprises: removing one or more acknowledgment messages identified as being a duplicate from a transmission buffer.

Aspect 10: The method of any of aspects 1 through 8, wherein the duplicate acknowledgment recovery procedure comprises: removing one or more acknowledgment messages identified as being a duplicate from a receive buffer.

Aspect 11: The method of any of aspects 1 through 8, wherein the duplicate acknowledgment recovery procedure comprises: transmitting a retransmission of a duplicate acknowledgment message having a first payload that is different than a second payload communicated in a prior transmission of the duplicate acknowledgment message, wherein the first payload fails to satisfy a checksum or error check procedure associated with the duplicate acknowledgment message.

Aspect 12: The method of any of aspects 1 through 8, wherein the duplicate acknowledgment recovery procedure indicates that transmission of the second acknowledgment message is prioritized over transmission of the first acknowledgment message via a radio bearer, a logical channel, or both.

Aspect 13: The method of any of aspects 1 through 8, wherein the duplicate acknowledgment recovery procedure comprises: transmitting or receiving the second acknowledgment message over a first radio link, a first component carrier, or both; and transmitting or receiving the second acknowledgment message over a second radio link, a second component carrier, or both.

Aspect 14: The method of any of aspects 1 through 13, wherein identifying the quantity of duplicate acknowledgment messages further comprises: identifying the quantity of duplicate acknowledgment messages during an observation time window, wherein a duration of the observation time window is based at least in part on one or more channel condition metrics of the wireless channel.

Aspect 15: The method of aspect 14, wherein the one or more channel condition metrics of the wireless channel comprises a pathloss metric, a round trip time, a layer two round trip time, an end-to-end round trip time, a block error rate, a layer one block error rate, a layer two block error rate, or any combination thereof.

Aspect 16: The method of any of aspects 14 through 15, wherein the duration of the observation time window is based at least in part on a radio access technology type of the wireless device used to communicate the plurality of data packets, a sub-carrier spacing used to communicate the plurality of data packets, a frequency band used to communicate the plurality of data packets, or any combination thereof.

Aspect 17: The method of any of aspects 14 through 16, wherein the duration of the observation time window is based at least in part on a configuration of a communication protocol used for communicating the plurality of data packets via the data connection.

Aspect 18: A wireless device for wireless communications, comprising one or more memories storing processor-executable code, and one or more processors coupled with the one or more memories and individually or collectively operable to execute the code to cause the wireless device to perform a method of any of aspects 1 through 17.

Aspect 19: A wireless device for wireless communications, comprising at least one means for performing a method of any of aspects 1 through 17.

Aspect 20: A non-transitory computer-readable medium storing code for wireless communications, the code comprising instructions executable by a processor to perform a method of any of aspects 1 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless device, comprising:
one or more memories storing processor-executable code; and
one or more processors coupled with the one or more memories and individually or collectively operable to execute the code to cause the wireless device to:
transmit or receive a plurality of data packets via a data connection established via a wireless channel, the plurality of data packets being a sequence of data packets communicated via the data connection;
identify a quantity of duplicate acknowledgment messages that are generated for the plurality of data packets, wherein a first acknowledgment message is identified as being a duplicate acknowledgment message based at least in part on a second acknowledgment message indicating successful receipt of a same packet as the first acknowledgment message and successful receipt of one or more subsequent packets in the sequence of data packets, and wherein the first acknowledgment message is identified as being the duplicate acknowledgment message based at least in part on the second acknowledgment message being generated within a time duration threshold of the first acknowledgment message; and
perform a duplicate acknowledgment recovery procedure based at least in part on the quantity of duplicate acknowledgment messages satisfying a trigger threshold.

2. The wireless device of claim 1, wherein one or more of the time duration threshold or the trigger threshold is based at least in part on one or more channel condition metrics of the wireless channel.

3. The wireless device of claim 2, wherein the one or more channel condition metrics of the wireless channel comprises a pathloss metric, a round trip time, a layer two round trip time, an end-to-end round trip time, a block error rate, a layer one block error rate, a layer two block error rate, or any combination thereof.

4. The wireless device of claim 1, wherein one or more of the time duration threshold or the trigger threshold is based at least in part on a radio access technology type of the wireless device used to communicate the plurality of data packets, a sub-carrier spacing used to communicate the plurality of data packets, a frequency band used to communicate the plurality of data packets, or any combination thereof.

5. The wireless device of claim 1, wherein one or more of the time duration threshold or the trigger threshold is based at least in part on a configuration of a communication protocol used for communicating the plurality of data packets via the data connection.

6. The wireless device of claim 1, wherein the one or more processors are individually or collectively further operable to execute the code to cause the wireless device to:
transmit or receive the second acknowledgment message via the data connection.

7. The wireless device of claim 1, wherein the plurality of data packets are received by the wireless device in accordance with the sequence and forwarded to a protocol layer stack for generating acknowledgment messages in a different sequential order.

8. The wireless device of claim 1, wherein the time duration threshold is based at least in part on an end-to-end round trip time for a transmission of at least one data packet of the plurality of data packets from a transmitter to the wireless device.

9. The wireless device of claim 1, wherein, to duplicate acknowledgment recovery procedure, the one or more processors are individually or collectively operable to execute the code to cause the wireless device to:
remove one or more acknowledgment messages identified as being a duplicate from a transmission buffer.

10. The wireless device of claim 1, wherein, to duplicate acknowledgment recovery procedure, the one or more processors are individually or collectively operable to execute the code to cause the wireless device to:
remove one or more acknowledgment messages identified as being a duplicate from a receive buffer.

11. The wireless device of claim 1, wherein, to duplicate acknowledgment recovery procedure, the one or more processors are individually or collectively operable to execute the code to cause the wireless device to:
transmit a retransmission of a duplicate acknowledgment message having a first payload that is different than a second payload communicated in a prior transmission of the duplicate acknowledgment message, wherein the first payload fails to satisfy a checksum or error check procedure associated with the duplicate acknowledgment message.

12. The wireless device of claim 1, wherein the duplicate acknowledgment recovery procedure indicates that transmission of the second acknowledgment message is prioritized over transmission of the first acknowledgment message via a radio bearer, a logical channel, or both.

13. The wireless device of claim 1, wherein, to duplicate acknowledgment recovery procedure, the one or more processors are individually or collectively operable to execute the code to cause the wireless device to:
transmit or receive the second acknowledgment message over a first radio link, a first component carrier, or both; and
transmit or receive the second acknowledgment message over a second radio link, a second component carrier, or both.

14. The wireless device of claim 1, wherein, to identify the quantity of duplicate acknowledgment messages, the one or more processors are individually or collectively further operable to execute the code to cause the wireless device to:
identify the quantity of duplicate acknowledgment messages during an observation time window, wherein a duration of the observation time window is based at least in part on one or more channel condition metrics of the wireless channel.

15. The wireless device of claim 14, wherein the one or more channel condition metrics of the wireless channel comprises a pathloss metric, a round trip time, a layer two round trip time, an end-to-end round trip time, a block error rate, a layer one block error rate, a layer two block error rate, or any combination thereof.

16. The wireless device of claim 14, wherein the duration of the observation time window is based at least in part on a radio access technology type of the wireless device used to communicate the plurality of data packets, a sub-carrier spacing used to communicate the plurality of data packets, a frequency band used to communicate the plurality of data packets, or any combination thereof.

17. The wireless device of claim 14, wherein the duration of the observation time window is based at least in part on a configuration of a communication protocol used for communicating the plurality of data packets via the data connection.

18. A method for wireless communications at a wireless device, comprising:
transmitting or receiving a plurality of data packets via a data connection established via a wireless channel, the plurality of data packets being a sequence of data packets communicated via the data connection;
identifying a quantity of duplicate acknowledgment messages that are generated for the plurality of data packets, wherein a first acknowledgment message is identified as being a duplicate acknowledgment message based at least in part on a second acknowledgment message indicating successful receipt of a same packet as the first acknowledgment message and successful receipt of one or more subsequent packets in the sequence of data packets, and wherein the first acknowledgment message is identified as being the duplicate acknowledgment message based at least in part on the second acknowledgment message being generated within a time duration threshold of the first acknowledgment message; and
performing a duplicate acknowledgment recovery procedure based at least in part on the quantity of duplicate acknowledgment messages satisfying a trigger threshold.

19. The method of claim 18, wherein one or more of the time duration threshold or the trigger threshold is based at least in part on one or more channel condition metrics of the wireless channel.

20. The method of claim 19, wherein the one or more channel condition metrics of the wireless channel comprises a pathloss metric, a round trip time, a layer two round trip time, an end-to-end round trip time, a block error rate, a layer one block error rate, a layer two block error rate, or any combination thereof.

21. The method of claim 18, wherein one or more of the time duration threshold or the trigger threshold is based at least in part on a radio access technology type of the wireless device used to communicate the plurality of data packets, a sub-carrier spacing used to communicate the plurality of data packets, a frequency band used to communicate the plurality of data packets, or any combination thereof.

22. The method of claim 18, wherein the time duration threshold is based at least in part on an end-to-end round trip time for a transmission of at least one data packet of the plurality of data packets from a transmitter to the wireless device.

23. The method of claim 18, wherein the duplicate acknowledgment recovery procedure comprises:
removing one or more acknowledgment messages identified as being a duplicate from a transmission buffer.

24. The method of claim 18, wherein the duplicate acknowledgment recovery procedure comprises:
removing one or more acknowledgment messages identified as being a duplicate from a receive buffer.

25. The method of claim 18, wherein the duplicate acknowledgment recovery procedure comprises:
transmitting a retransmission of a duplicate acknowledgment message having a first payload that is different than a second payload communicated in a prior transmission of the duplicate acknowledgment message, wherein the first payload fails to satisfy a checksum or error check procedure associated with the duplicate acknowledgment message.

26. The method of claim 18, wherein the duplicate acknowledgment recovery procedure indicates that transmission of the second acknowledgment message is prioritized over transmission of the first acknowledgment message via a radio bearer, a logical channel, or both.

27. The method of claim 18, wherein the duplicate acknowledgment recovery procedure comprises:
transmitting or receiving the second acknowledgment message over a first radio link, a first component carrier, or both; and
transmitting or receiving the second acknowledgment message over a second radio link, a second component carrier, or both.

28. The method of claim 18, wherein identifying the quantity of duplicate acknowledgment messages further comprises:
identifying the quantity of duplicate acknowledgment messages during an observation time window, wherein a duration of the observation time window is based at least in part on one or more channel condition metrics of the wireless channel.

29. A wireless device for wireless communications, comprising:
means for transmitting or receiving a plurality of data packets via a data connection established via a wireless channel, the plurality of data packets being a sequence of data packets communicated via the data connection;
means for identifying a quantity of duplicate acknowledgment messages that are generated for the plurality of data packets, wherein a first acknowledgment message is identified as being a duplicate acknowledgment message based at least in part on a second acknowledgment message indicating successful receipt of a same packet as the first acknowledgment message and successful receipt of one or more subsequent packets in the sequence of data packets, and wherein the first acknowledgment message is identified as being the duplicate acknowledgment message based at least in part on the second acknowledgment message being generated within a time duration threshold of the first acknowledgment message; and
means for performing a duplicate acknowledgment recovery procedure based at least in part on the quantity of duplicate acknowledgment messages satisfying a trigger threshold.

30. A non-transitory computer-readable medium storing code for wireless communications, the code comprising instructions executable by one or more processors to:
transmit or receive a plurality of data packets via a data connection established via a wireless channel, the plurality of data packets being a sequence of data packets communicated via the data connection;
identify a quantity of duplicate acknowledgment messages that are generated for the plurality of data packets, wherein a first acknowledgment message is identified as being a duplicate acknowledgment message based at least in part on a second acknowledgment message indicating successful receipt of a same packet as the first acknowledgment message and successful receipt of one or more subsequent packets in the sequence of data packets, and wherein the first acknowledgment message is identified as being the duplicate acknowledgment message based at least in part on the second acknowledgment message being generated within a time duration threshold of the first acknowledgment message; and
perform a duplicate acknowledgment recovery procedure based at least in part on the quantity of duplicate acknowledgment messages satisfying a trigger threshold.
